(19) United States
(12) Patent Application Publication
(10) Pub. No.: US 2024/0335063 A1
(43) Pub. Date: Oct. 10, 2024

(54) COOKING DEVICE, CONTROL METHOD AND APPARATUS FOR SAME, AND STORAGE MEDIUM

(71) Applicant: FOSHAN SHUNDE MIDEA ELECTRICAL HEATING APPLIANCES MANUFACTURING CO., LTD., FOSHAN (CN)

(72) Inventors: Mengjie LIANG, FOSHAN (CN); Pengbo REN, FOSHAN (CN)

(21) Appl. No.: 18/619,197

(22) Filed: Mar. 28, 2024

(30) Foreign Application Priority Data
Apr. 10, 2023 (CN) 202310379521.1

(51) Int. Cl. A47J 36/20; A47J 27/00

(52) U.S. Cl. CPC A47J 36/20; A47J 27/002

(57) ABSTRACT

Provided is a cooking appliance. The cooking appliance includes a cooking body, an inner pot, and a separation device. The cooking body defines an accommodation cavity. The inner pot defines a cooking cavity. The separation device has a liquid storage cavity and a backflow channel. The backflow channel has a first liquid flowing portion and a second liquid flowing portion. The liquid storage cavity is in communication with the backflow channel through the first liquid flowing portion. The cooking cavity is in communication with the backflow channel through the second liquid flowing portion. The separation device has a liquid inlet portion, and the liquid storage cavity is in communication with the cooking cavity through the liquid inlet portion. The separation device is provided with a flow guide portion at a bottom of the separation device.

### CROSS-REFERENCES TO RELATED APPLICATIONS

This application claims priorities to Chinese Patent Applications No. 202321032606.4 and No. 202321033369.3, filed on Apr. 28, 2023, the entire contents of which are incorporated herein by reference.

### FIELD

The present disclosure relates to the field of cooking appliances, and in particular, to a cooking appliance.

### BACKGROUND

During simmering meat soup, oil in the meat soup tends to be separated from meat and float atop the meat soup. On the one hand, the oil affects taste of the meat soup, and on the other hand, the oil does not conform to a current healthy diet requirement for low fat. When the oil in the meat soup needs to be removed, a user needs to use a ladle to ladle out the floating oil from the meat soup.

To this end, the related art discloses an oil filtration device. When the meat soup is boiled, the meat soup can flow into the oil filtration device. As a result, the oil can be separated from the meat soup. However, the flow of the meat soup into the oil filtration device is time-consuming. In one embodiment, when the meat soup is boiled, bubbles may be generated in the meat soup. The generated bubbles tend to be accumulated below the oil filtration device, which causes the oil filtration device to fluctuate easily, thereby affecting oil filtering effect of the oil filtration device.

### SUMMARY

The present disclosure aims to solve at least one of the problems in the related art to some extent. To this end, the present disclosure provides a cooking appliance. The cooking appliance can separate oil in meat soup quickly and automatically, thereby preventing a separation device from fluctuating, and thus has advantages of improving efficiency of oil-water separation, reducing a workload of a user, saving time and energy of the user, and the like.

The cooking appliance according to embodiments of the present disclosure includes a cooking body, an inner pot, and a separation device. The cooking body defines an accommodation cavity. The inner pot is provided in the accommodation cavity and defines a cooking cavity. The separation device is provided in the inner pot and has a liquid storage cavity and a backflow channel. The backflow channel has a first liquid flowing portion and a second liquid flowing portion disposed above the first liquid flowing portion. The liquid storage cavity is in communication with the backflow channel through the first liquid flowing portion. The cooking cavity is in communication with the backflow channel through the second liquid flowing portion. The separation device has a liquid inlet portion, and the liquid storage cavity is in communication with the cooking cavity through the liquid inlet portion. The separation device is provided with a flow guide portion at a bottom of the separation device. The flow guide portion is configured to guide a liquid in the cooking cavity to flow towards the liquid inlet portion.

According to the embodiments of the present disclosure, during cooking, the cooking appliance can separate the oil in the meat soup quickly and automatically, thereby preventing the separation device from fluctuating, and thus has the advantages of improving the efficiency of oil-water separation, reducing the workload of the user, and saving the user's time and energy.

In addition, the cooking appliance according to the embodiments of the present disclosure may further have the following additional embodiments.

According to some embodiments of the present disclosure, the cooking body includes a first heating device. The first heating device is located below a bottom wall of the inner pot. The first heating device includes a first heating element and a second heating element that are capable of operating independently of each other. The flow guide portion is located at a position corresponding to the first heating device.

According to some embodiments of the present disclosure, the first heating element and the second heating element are each of an annular structure, and the first heating element is located outside the second heating element.

According to some embodiments of the present disclosure, a projection of a lowest part of an outer surface of a bottom wall of the separation device on the bottom wall of the inner pot is located in a first predetermined region. The first predetermined region is a region where a part between the first heating element and the second heating element is projected onto the bottom wall of the inner port, or the first heating element and the second heating element are both in contact with the inner pot. A first inner contour line of the first predetermined region are located inside a region where the second heating element is in contact with the bottom wall of the inner pot, and a first outer contour line of the first predetermined region is located outside a region where the first heating element is in contact with the bottom wall of the inner pot. A distance between the first inner contour line and the region where the second heating element is in contact with the bottom wall of the inner pot is smaller than or equal to 15 mm and/or a distance between the first outer contour line and the region where the first heating element is in contact with the bottom wall of the inner pot is smaller than or equal to 15 mm.

According to some embodiments of the present disclosure, the liquid inlet portion includes a first liquid inlet portion, and the flow guide portion includes a first flow guide portion located at a position corresponding to the first heating element and extending towards the first liquid inlet portion from bottom to top.

According to some embodiments of the present disclosure, the liquid inlet portion further includes a second liquid inlet portion, and the flow guide portion further includes a second flow guide portion located at a position corresponding to the second heating element and extending towards the second liquid inlet portion from bottom to top.

According to some embodiments of the present disclosure, the first flow guide portion and the second flow guide portion are each of an annular structure, and the first flow guide portion is located outside the second flow guide portion.

According to some embodiments of the present disclosure, the first flow guide portion and the second flow guide portion extend away from each other from bottom to top.

According to some embodiments of the present disclosure, the first flow guide portion and/or the second flow guide portion include an inclined flow guide surface and/or an arc flow guide surface.

According to some embodiments of the present disclosure, the first flow guide portion and/or the second flow guide portion include the inclined flow guide surface. An angle between the inclined flow guide surface and a horizontal plane ranges from 10° to 60°.

According to some embodiments of the present disclosure, the first flow guide portion and/or the second flow guide portion include the arc flow guide surface. The arc flow guide surface is a convex surface.

According to some embodiments of the present disclosure, the separation device includes a liquid storage container provided in the cooking cavity and an oil blocking member. The backflow channel is defined by the oil blocking member and the liquid storage container. The oil blocking member is at least partially disposed in the liquid storage container. The first flow guide portion and the second flow guide portion are disposed at an outer surface of a bottom wall of the liquid storage container, or the oil blocking member is disposed outside the liquid storage container. The first flow guide portion and the second flow guide portion are disposed at the oil blocking member.

According to some embodiments of the present disclosure, the first liquid inlet portion includes a first liquid inlet formed at a peripheral wall of the liquid storage container or an upper opening formed at the peripheral wall of the liquid storage container.

According to some embodiments of the present disclosure, the second liquid inlet portion is disposed at the oil blocking member or the liquid storage container.

According to some embodiments of the present disclosure, the first liquid inlet portion includes first liquid inlets formed at a peripheral wall of the liquid storage container, and a total area of the first liquid inlets is greater than or equal to 20 mm².

According to some embodiments of the present disclosure, the liquid storage container has a bottom wall and a peripheral wall, and the liquid storage container has a liquid passing opening formed at a middle part of the bottom wall of the liquid storage container. The oil blocking member is disposed in the liquid storage container and covers the liquid passing opening, and the second liquid inlet portion is disposed at the oil blocking member and faces towards the liquid passing opening.

According to some embodiments of the present disclosure, the bottom wall of the liquid storage container has an annular flange extending upwards, and the liquid passing opening is formed by an upper opening of the annular flange. The oil blocking member has a top wall and a peripheral wall. The second liquid inlet portion is disposed at the top wall of the oil blocking member. The peripheral wall of the oil blocking member is located outside the annular flange, and the backflow channel is at least partially defined by the annular flange and the peripheral wall of the oil blocking member.

According to some embodiments of the present disclosure, the cooking body includes a second heating device provided below the inner pot, and a projection of a lowest part of an outer surface of a bottom wall of the separation device on a bottom wall of the inner pot is located in a second predetermined region. The second predetermined region is a region where the second heating device is projected onto the bottom wall of the inner pot; or the second heating device is in contact with the inner pot, and the second inner contour line of the second predetermined region is located inside a region where the second heating device is in contact with the bottom wall of the inner pot, and a second outer contour line of the second predetermined region is located outside the region where the second heating device is in contact with the bottom wall of the inner pot. A distance between the second inner contour line and the region where the second heating device is in contact with the bottom wall of the inner pot is smaller than or equal to 10 mm and/or a distance between the second outer contour line and the region where the second heating device is in contact with the bottom wall of the inner pot is smaller than or equal to 10 mm.

According to some embodiments of the present disclosure, the flow guide portion extends towards at least one liquid inlet portion from bottom to top.

According to some embodiments of the present disclosure, the flow guide portion includes an inclined flow guide surface and/or an arc flow guide surface.

According to some embodiments of the present disclosure, the flow guide portion includes the inclined flow guide surface. An angle between the inclined flow guide surface and a horizontal plane ranges from 10° to 60°.

According to some embodiments of the present disclosure, the flow guide portion includes the arc flow guide surface. The arc flow guide surface is a convex surface.

According to some embodiments of the present disclosure, the inner pot is provided with a positioning protrusion at a side wall of the inner pot, and the separation device is provided with a support edge engaged with the positioning protrusion, or the separation device is provided with a protruding rib at a side wall of the separation device and the protruding rib is engaged with the side wall of the inner pot, or the separation surface is supported at an edge of the inner pot, or the separation surface is supported at a bottom wall of the inner pot.

Additional embodiments of the present disclosure will be provided in part in the following description, or will become apparent in part from the following description, or can be learned from practicing of the present disclosure.

### BRIEF DESCRIPTION OF THE DRAWINGS

The above and/or additional aspects and advantages of the present disclosure will become more apparent and more understandable from the following description of embodiments taken in conjunction with the accompanying drawings, in which:

FIG. 1 is a schematic structural view of a cooking appliance according to an embodiment of the present disclosure in an embodiment.

FIG. 2 is an enlarged view at part A in FIG. 1.

FIG. 3 is a schematic structural view of a cooking appliance according to an embodiment of the present disclosure in another embodiment.

FIG. 4 is an enlarged view at part B in FIG. 3.

FIG. 5 is a schematic structural view of a liquid storage container and an oil blocking member according to an embodiment of the present disclosure, and the oil blocking member is located outside the liquid storage container.

FIG. 6 is a schematic structural view of a cooking appliance according to an embodiment of the present disclosure in an embodiment.

FIG. 7 is an enlarged view at part D in FIG. 6.

FIG. 8 is a schematic structural view of a cooking appliance according to an embodiment of the present disclosure in another embodiment.

FIG. 9 is an enlarged view at part E in FIG. 8.

FIG. 10 is a schematic structural view of a cooking appliance according to an embodiment of the present disclosure in yet another embodiment.

FIG. 11 is an enlarged view at part F in FIG. 10.

FIG. 12 is a schematic structural view of a liquid storage container and an oil blocking member according to an embodiment of the present disclosure, and the oil blocking member is located outside the liquid storage container.

### REFERENCE NUMERALS

cooking appliance 1,
cooking body 10,
inner pot 20, cooking cavity 21, positioning protrusion 22,
separation device 30, liquid storage container 31, liquid passing opening 311, annular flange 312, oil blocking member 32, liquid storage cavity 33,
backflow channel 34, first liquid flowing portion 341, second liquid flowing portion 342,
liquid inlet portion 35, second liquid inlet portion 351, first liquid inlet 352,
flow guide portion 36, second flow guide portion 361, first flow guide portion 362, inclined flow guide surface 363, arc flow guide surface 364,
support edge 37, first heating device 40, second heating element 41, first heating element 42,
second heating device 50.

### DETAILED DESCRIPTION OF THE DISCLOSURE

Embodiments of the present disclosure will be described in detail below with reference to examples thereof as illustrated in the accompanying drawings, throughout which same or similar elements, or elements having same or similar functions, are denoted by same or similar reference numerals. The embodiments described below with reference to the drawings are illustrative only, and are intended to explain, rather than limiting, the present disclosure.

In the description of the present disclosure, it needs to be understood that, terms such as “center,” “longitudinal,” “lateral,” “vertical,” “width,” “thickness,” “top,” “bottom,” “in,” and “out” refer to the directions and location relations which are the directions and location relations shown in the drawings, and for describing the present disclosure and for describing in simple, and which are not intended to indicate or imply that the device or the elements are disposed to locate at the specific directions or are structured and performed in the specific directions, which could not be understood to the limitation of the present disclosure.

In addition, terms such as “first” and “second” are used herein for purposes of description and are not intended to indicate or imply relative importance or significance. Therefore, the feature associated with “first” and “second” may include one or more this feature distinctly or implicitly. In the description of the present disclosure, “a plurality of” means two or more than two, unless specified otherwise.

In the present disclosure, unless otherwise clearly specified and limited, terms such as “install,” “connect,” “connect to,” “fix,” and the like should be understood in a broad sense. For example, it may be a fixed connection or a detachable connection or connection as one piece; mechanical connection or electrical connection or communication; direct connection or indirect connection through an intermediate; internal communication of two components or the interaction relationship between two components. The specific meaning of the above-mentioned terms in the present disclosure can be understood according to specific circumstances.

In the present disclosure, unless otherwise clearly specified and limited, a structure in which a first feature is “on” or “below” a second feature may include an embodiment in which the first feature is in direct contact with the second feature, and may also include an embodiment in which the first feature and the second feature are not in direct contact with each other, but are in contact via an additional feature formed therebetween. Furthermore, a first feature “on,” “above” or “on top of” a second feature may include an embodiment in which the first feature is orthogonally or obliquely “on,” “above” or “on top of” the second feature, or just means that the first feature is at a height higher than that of the second feature.

A cooking appliance 1 in the embodiments of the present disclosure is described below with reference to the accompanying drawings.

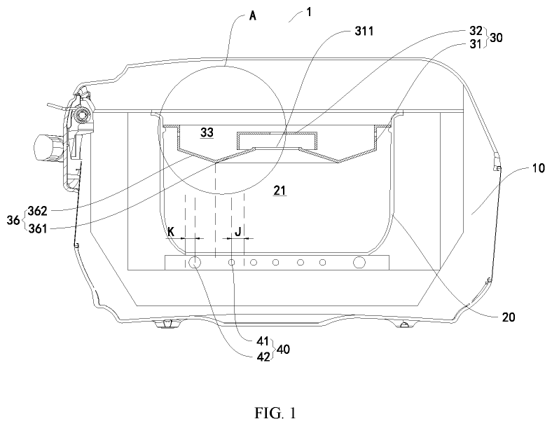

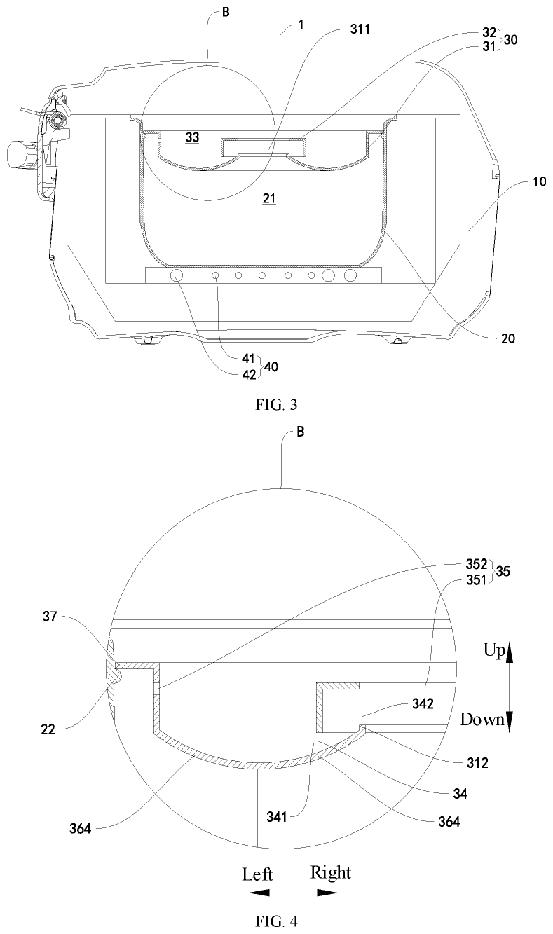

As illustrated in FIG. 1 to FIG. 5, the cooking appliance 1 according to an embodiment of the present disclosure includes a cooking body 10, an inner pot 20, and a separation device 30.

The cooking body 10 defines an accommodation cavity. The inner pot 20 is provided in the accommodation cavity. The inner pot 20 defines a cooking cavity 21. A user may place food materials in the cooking cavity 21, and the food materials in the cooking cavity 21 can be cooked by the cooking appliance 1. The separation device 30 is provided in the inner pot 20. The separation device 30 has a liquid storage cavity 33 and a backflow channel 34. The backflow channel 34 has a first liquid flowing portion 341 and a second liquid flowing portion 342. The liquid storage cavity 33 is in communication with the backflow channel 34 through the first liquid flowing portion 341. The cooking cavity 21 is in communication with the backflow channel 34 through the second liquid flowing portion 342. The second liquid flowing portion 342 is disposed above the first liquid flowing portion 341. The separation device 30 has a liquid inlet portion 35, and the liquid storage cavity 33 is in communication with the cooking cavity 21 through the liquid inlet portion 35.

The cooking body 10 includes a first heating device 40. The first heating device 40 is located below a bottom wall of the inner pot 20. The first heating device 40 includes a first heating element 42 and a second heating element 41 that are capable of operating independently of each other. The first heating element 42 and the second heating element 41 may respectively heat liquids in different regions in the cooking cavity 21 to boil a liquid in the cooking cavity 21 and allow the liquid in the cooking cavity 21 to flow into the liquid storage cavity 33 from the liquid inlet portion 35.

In an exemplary embodiment of the present disclosure, the liquid in the cooking cavity is boiled by the first heating device 40. After the liquid in the cooking cavity 21 flows into the liquid storage cavity 33 from the liquid inlet portion 35, a liquid of a low density floats at a position above the liquid storage cavity 33, and a liquid of a high density is accumulated below the liquid storage cavity 33. The liquid of the high density at a lower part of the liquid storage cavity 33 may flow into the backflow channel 34 from the first liquid flowing portion 341. As a liquid level rises within the liquid storage cavity 33, the liquid of the high density in the backflow channel 34 may flow into the cooking cavity 21 from the second liquid flowing portion 342. In this way, liquids of different densities in the inner pot 20 can be separated from each other. Therefore, the liquid of the low density is allowed to be accumulated in the liquid storage cavity 33. In one embodiment, the liquid of the high density is allowed to be accumulated in the cooking cavity 21.

In addition, after the liquid of the high density flows into the backflow channel 34 from the first liquid flowing portion 341, and after the liquid flows into the cooking cavity 21 from the second liquid flowing portion 342 along the backflow channel 34, the liquid of the low density can be accumulated in the liquid storage cavity 33. In this way, the second liquid flowing portion 342 is allowed to be located above the first liquid flowing portion 341. Therefore, the liquid of the low density can be stored in the liquid storage cavity 33, thereby avoiding the flow of the liquid of the low density into the cooking cavity 21.

The separation device 30 is provided with a flow guide portion 36 at a bottom of the separation device 30. The flow guide portion 36 is configured to guide the liquid in the cooking cavity 21 to flow towards the liquid inlet portion 35. The flow guide portion 36 is located at a position corresponding to the first heating device 40. In this way, when boiling the liquid in the cooking cavity 21 by the first heating element 42 and the second heating element 41, the first heating element 42 and the second heating element 41 can quickly heat the liquid near the flow guide portion 36. Further, when boiling the liquid near the flow guide portion 36, the liquid can flow into the liquid inlet portion 35 along the flow guide portion 36. Furthermore, the liquid in the cooking cavity 21 can quickly flow into the liquid storage cavity 33 from the liquid inlet portion 35 along the flow guide portion 36. Therefore, an improvement in efficiency of separating the liquids of different densities by the cooking appliance 1 is facilitated. As a result, the liquid of the low density can be accumulated in the liquid storage cavity 33, and the liquid of the high density can be accumulated in the cooking cavity 21.

In addition, when the first heating element 42 and the second heating element 41 boil the liquid in the cooking cavity 21, the bubbles generated in the cooking cavity 21 move upwards to the vicinity of the flow guide portion 36. In one embodiment, the bubbles may flow into the liquid inlet portion 35 along the flow guide portion 36 at the bottom of the separation device 30. In this way, the bubbles can be prevented from being accumulated at the bottom of the separation device 30. As a result, the separation device 30 can be prevented from being driven by the bubbles to fluctuate when the bubbles fluctuate, thereby avoiding an influence on a position of the separation device 30. Therefore, the separation device 30 can smoothly separate the liquids with different densities.

It should be explained herein that when the liquid in the cooking cavity 21 is heated, one of the first heating element 42 and the second heating element 41 may heat the liquid separately, or the first heating element 42 and the second heating element 41 may heat the liquid together, which may be determined according to regions to be heated and a position of the flow guide portion 36 relative to the first heating device 40, and the present disclosure is not limited in this regard.

In an exemplary embodiment of the present disclosure, by providing the flow guide portion 36 at the bottom of the separation device 30, the flow guide portion 36 can be located at a position corresponding to the first heating device 40 to heat the liquid in the cooking cavity 21 by the first heating element 42 and the second heating element 41. When the liquid in the cooking cavity 21 is boiled, the bubbles generated by heating are located closer to the flow guide portion 36. The bubbles may move upwards to the bottom of the separation device 30 and flow to the liquid inlet portion 35 along the flow guide portion 36 at the bottom of the separation device 30. In this way, the bubbles are prevented from being accumulated at the bottom of the separation device 30. As a result, it is possible to prevent the bubbles from driving the separation device 30 to fluctuate when the bubbles fluctuate, thereby avoiding the influence on the position of the separation device 30. Therefore, the separation device 30 can smoothly separate the liquids of different densities.

Meanwhile, the liquid in the cooking cavity 21 is heated by the first heating element 42 and the second heating element 41. In one embodiment, a liquid in a region of the cooking cavity 21 closer to the flow guide portion 36 may be quickly boiled, thereby allowing the liquid in this region to flow to the liquid inlet portion 35 along the flow guide portion 36 and then flow into the liquid storage cavity 33 from the liquid inlet portion 35. In this way, during the separation of the liquids of different densities in the cooking cavity 21, a reduction in a time for the cooking appliance 1 to separate the oil is facilitated. Therefore, the cooking appliance 1 can flexibly change a heating temperature as required, which makes the cooking appliance 1 better cook soup.

According to the cooking appliance 1 of the embodiments of the present disclosure, by correspondingly providing the flow guide portion 36 and the first heating device 40, the liquid near the flow guide portion 36 is accurately heated by the first heating device 40. In this way, bubbles and boiled liquids generated by the heating can quickly flow into the liquid storage cavity 33 along the flow guide portion 36. On the one hand, an improvement in efficiency of the liquid in the cooking cavity 21 flowing into the liquid storage cavity 33 is facilitated, to quickly and automatically separate the oil in the meat soup in the cooking cavity 21 by the separation device 30. On the other hand, the bubbles can be prevented from being accumulated at the bottom of the separation device 30. As a result, it is possible to prevent the bubbles from driving the separation device 30 to fluctuate when the bubbles fluctuate, thereby avoiding the influence on the position of the separation device 30. Therefore, the separation device 30 can smoothly separate the liquids with different densities.

In an exemplary embodiment of the present disclosure, when the cooking appliance 1 performs soup cooking, the first heating element 42 and the second heating element 41 heat the meat soup. When the meat soup in the cooking cavity 21 is boiled, the bubbles and boiled liquids generated by the heating can flow to the liquid inlet portion 35 along the flow guide portion 36. As a result, the liquid in the cooking cavity 21 can quickly flow into the liquid storage cavity 33 along the flow guide portion 36, to quickly and automatically separate the oil in the meat soup of the cooking cavity 21 by using the separation device 30.

In an exemplary embodiment of the present disclosure, after the liquid in the cooking cavity 21 flows into the liquid storage cavity 33 along the flow guide portion 36, soup of a high density in the liquid storage cavity 33 flows into the backflow channel 34 from the first liquid flowing portion 341, and then flows into the cooking cavity 21 from the second liquid flowing portion 342 along the backflow channel 34. Oil of a low density is stored in the liquid storage cavity 33. As a result, the soup and the oil in the meat soup can be separated from each other. In this way, after the soup cooking is completed, the user can obtain soup in which the oil has been removed from the cooking cavity 21 without additionally removing the oil from meat soup in the cooking cavity 21. Therefore, a workload of the user is reduced, and time and effort of the user are saved. In addition, the efficiency of oil-water separation is improved. In one embodiment, it is convenient to improve the effect of oil-water separation.

Meanwhile, the bubbles generated when the first heating element 42 and the second heating element 41 heat the meat soup may move upwards to the vicinity of the flow guide portion 36, and flow to the liquid inlet portion 35 along the flow guide portion 36. In this way, the bubbles can be prevented from being accumulated at the bottom of the separation device 30. As a result, it is possible to prevent the bubbles from driving the separation device 30 to fluctuate when the bubbles fluctuate, thereby avoiding the influence on the position of the separation device 30. Therefore, the separation device 30 can smoothly separate liquids of different densities.

Therefore, for the cooking appliance 1 according to the embodiments of the present disclosure, a liquid at a designated region in the cooking cavity 21 can be accurately heated, thereby allowing the liquid near the flow guide portion 36 to quickly flow into the liquid storage cavity 33 along the flow guide portion 36. As a result, the oil in the meat soup can be separated quickly. Meanwhile, the flow guide portion 36 may disperse the bubbles at the bottom of the separation device 30, to prevent the separation device 30 from being driven by the bubbles to fluctuate. Therefore, the efficiency of oil-water separation can be improved, thereby reducing the workload of the user, saving the time and energy of the user.

A cooking appliance 1 according to a specific embodiment of the present disclosure will be described below with reference to the accompanying drawings.

As illustrated in FIG. 1 to FIG. 5, the cooking appliance 1 according to an embodiment of the present disclosure includes a cooking body 10, an inner pot 20, and a separation device 30.

In some embodiments of the present disclosure, the first heating element 42 and the second heating element 41 are each of an annular structure. The first heating element 42 is located outside the second heating element 41. In this way, a heating area of the first heating element 42 and a heating area of the second heating element 41 can be increased. Further, the first heating element 42 and the second heating element 41 can heat the liquid in the cooking cavity 21 quickly and uniformly. An improvement in heating efficiency of the first heating device 40 is facilitated, thereby allowing the liquid in the cooking cavity 21 to be quickly boiled. In one embodiment, the boiled liquid in the cooking cavity 21 can quickly flow into the liquid storage cavity 33 along the flow guide portion 36. Therefore, the liquids of different densities in the cooking cavity 21 can be separated quickly.

As illustrated in FIG. 1, in the embodiment, the first heating element 42 and the second heating element 41 are disposed below the bottom wall of the inner pot 20. A downward projection of the inner pot 20 in an up-down direction is circular. The first heating element 42 is located outside the second heating element 41, and thus the first heating element 42 and the second heating element 41 are each formed into an annular structure. In this way, the first heating element 42 can heat a liquid at a side of the inner pot 20. In one embodiment, the second heating member 41 can heat a liquid in the middle of the inner pot 20. Further, the first heating member 42 and the second heating member 41 can fully and uniformly heat the liquid in the cooking cavity 21. Therefore, the boiled liquid in the cooking cavity 21 can quickly flow into the liquid storage cavity 33 along the flow guide portion 36.

The second heating element 41 can heat the liquid in the middle of the cooking cavity 21. The first heating element 42 can heat the liquid at the side of the cooking cavity 21. When the liquid in the cooking cavity 21 is heated, one of the first heating element 42 and the second heating element 41 may heat the liquid separately, or the first heating element 42 and the second heating element 41 may heat the liquid together, which may be determined according to regions to be heated and the position of the flowguide portion 36 relative to the first heating device 40, and the present disclosure is not limited in this regard.

In some other embodiments of the present disclosure, as illustrated in FIG. 1, a projection of a lowest part of an outer surface of a bottom wall of the separation device 30 on the bottom wall of the inner pot 20 is located in a first predetermined region. In this way, a liquid in a region corresponding to the first predetermined region is accurately heated by the first heating device 40, thereby allowing the first heating device 40 to heat the liquid at the bottom of the separation device 30. Further, the liquid in this region is quickly boiled, thereby allowing the liquid below the separation device 30 to flow to the liquid inlet portion 35 along the flow guide portion 36. Therefore, the liquid in the cooking cavity 21 can smoothly flow into the liquid storage cavity 33.

Meanwhile, when the first heating device 40 heats the liquid in the cooking cavity 21, the bubbles generated by the heating are located closer to the flow guide portion 36. In one embodiment, the bubbles can move upwards to the bottom of the separation device 30 and flow to the liquid inlet portion 35 along the flow guide portion 36 at the bottom of the separation device 30. Therefore, the bubbles can be prevented from being accumulated at the bottom of the separation device 30. As a result, it is possible to prevent the bubbles from driving the separation device 30 to fluctuate when the bubbles fluctuate, thereby avoiding the influence on the position of the separation device 30. Therefore, the separation device 30 can smoothly separate the liquids of different densities

In some embodiments, the first predetermined region is a region where a part between the first heating element 42 and the second heating element 41 is projected onto the bottom wall of the inner pot 20. The first heating device 40 and the first heating device 40 can fully heat the liquid in the region corresponding to the first predetermined region. Further, the first heating member 42 and the second heating member 41 can fully heat a liquid at the outer surface of the bottom wall of the separation device 30, thereby allowing the bubbles and boiled liquids in the cooking cavity 21 to flow to the liquid inlet portion 35 along the flow guide portion 36. In this way, on the one hand, the liquid in the cooking cavity 21 can smoothly flow into the liquid storage cavity 33. On the other hand, the bubbles can be prevented from being accumulated at the bottom of the separation device 30. As a result, it is possible to prevent the bubbles from driving the separation device 30 to fluctuate, thereby avoiding the influence on the position of the separation device 30. Therefore, the separation device 30 can smoothly separate the liquids of different densities.

In some embodiments, the first heating element 42 includes first heating portions. The second heating element 41 includes second heating portions. The first heating portions and the second heating portions are arranged at intervals horizontally. A projection of the first heating portions on the bottom wall of the inner pot 20 in the up-down direction and a projection of the second heating portions on the bottom wall of the inner pot 20 in the up-down direction are projection regions. A whole region formed by the projection regions is a region where the first heating element 42 and the second heating element 41 are projected onto the bottom wall of the inner pot 20, and this region is the first predetermined region.

In some examples, the cooking appliance 1 includes a heat conduction plate and a heating pipe. The heating pipe is embedded into the heat conduction plate. The heat conduction plate is in contact with the inner pot. The heating pipe is not in contact with the inner pot 20. The first heating element 42 is formed as a first heating pipe. The second heating element 41 is formed as a second heating pipe. Both the first heating element 42 and the second heating element 41 are not in contact with the inner pot 20. The first predetermined region is a region where a part between the first heating pipe and the second heating pipe is projected onto the bottom wall of the inner pot 20.

In some other examples, the cooking appliance 1 includes a winding coil. The winding coil is not in contact with the inner pot 20. When the winding coil is powered on, the winding coil generates a variable magnetic field to heat the inner pot 20. The first heating element 42 is formed as a first winding coil. The second heating element 41 is formed as a second winding coil. The first heating element 42 and the second heating element 41 are each not in contact with the inner pot 20. The first predetermined region is a region where a part between the first winding coil and the second winding coil is projected onto the bottom wall of the inner pot 20.

In some other embodiments, as illustrated in FIG. 1, the first heating element 42 and the second heating element 41 are both in contact with the inner pot 20. A first inner contour line of the first predetermined region is located inside a region where the second heating element 41 is in contact with the bottom wall of the inner pot 20. A distance between the first inner contour line and the region where the second heating element 41 is in contact with the bottom wall of the inner pot 20 is smaller than or equal to 15 mm. In this way, the second heating element 41 can fully heat the liquid in the region corresponding to the first predetermined region. Further, the liquid at the outer surface of the bottom wall of the separation device 30 is fully heated. Furthermore, the bubbles and boiled liquids in the cooking cavity 21 can flow to the liquid inlet portion 35 along the flow guide portion 36. As a result, the liquid in the cooking cavity 21 can smoothly flow into the liquid storage cavity 33.

In some examples, the second heating element 41 includes second heating portions. The second heating portions is arranged at intervals horizontally. Each of the second heating portions is in in contact with the bottom wall of the inner pot 20 at different positions. A whole region formed at the contact positions is the region where the second heating element 41 is in contact with the bottom wall of the inner pot 20. The first inner contour line of the first predetermined region is located inside the region where the second heating element 41 is in contact with the bottom wall of the inner pot 20.

A first outer contour line of the first predetermined region is located outside a region where the first heating element 42 is in contact with the bottom wall of the inner pot 20. A distance between the first outer contour line and the region where the first heating element 42 is in contact with the bottom wall of the inner pot 20 is smaller than or equal to 15 mm. In this way, the first heating element 42 can fully heat the liquid in the region corresponding to the first predetermined region. Further, the liquid at the outer surface of the bottom wall of the separation device 30 is fully heated. Furthermore, the bubbles and boiled liquids in the cooking cavity 21 can flow to the liquid inlet portion 35 along the flow guide portion 36. As a result, the liquid in the cooking cavity 21 can smoothly flow into the liquid storage cavity 33.

In some examples, the first heating element 42 includes first heating portions. The first heating portions is arranged at intervals horizontally. Each of the first heating portions is in in contact with the bottom wall of the inner pot 20 at different positions. A whole region formed at the contact positions is the region where the first heating element 42 is in contact with the bottom wall of the inner pot 20. The first outer contour line of the first predetermined region is located outside the region where the first heating element 42 is in contact with the bottom wall of the inner pot 20.

In some examples, the first inner contour line of the first predetermined region is located inside the projection of the lowest part of the outer surface of the bottom wall of the separation device 30 on the bottom wall of the inner pot 20. The distance between the first inner contour line and the region where the second heating element 41 is in contact with the bottom wall of the inner pot 20 is denoted as J, and J is smaller than or equal to 15 mm. For example, the distance J between the first inner contour line and the region where the second heating element 41 is in contact with the bottom wall of the inner pot 20 is 5 mm, 8 mm, 10 mm, 12 mm, or 15 mm.

The first outer contour line of the first predetermined region is located outside the projection of the lowest part of the outer surface of the bottom wall of the separation device 30 on the bottom wall of the inner pot 20. The distance between the first outer contour line and the region where the first heating element 42 is in contact with the bottom wall of the inner pot 20 is denoted as K, and K is smaller than or equal to 15 mm. For example, the distance K between the first outer contour line and the region where the first heating element 42 is in contact with the bottom wall of the inner pot 20 is 5 mm, 8 mm, 10 mm, 12 mm, or 15 mm.

It should be explained here that the terms “inside” and “outside” herein are described with respect to an axis of the cooking cavity 21. A side close to the axis of the cooking cavity 21 in the region where the second heating element 41 is in contact with the bottom wall of the inner pot 20 is referred to as inside the region where the second heating element 41 is in contact with the bottom wall of the inner pot 20, and a side away from the axis of the cooking cavity 21 in the region where the first heating element 42 is in contact with the bottom wall of the inner pot 20 is referred to as outside the region where the first heating element 42 is in contact with the bottom wall of the inner pot 20.

In some embodiments, the cooking appliance 1 includes a heating plate. The heating plate is in contact with the inner pot 20. The first heating element 42 is formed as the first heating plate. The second heating element 41 is formed as the second heating plate. The first heating element 42 and the second heating element 41 are both in contact with the inner pot 20. The first inner contour line of the first predetermined region is located inside a region where the second heating plate is in contact with the bottom wall of the inner pot 20. The first outer contour line of the first predetermined region is located outside a region where the first heating plate is in contact with the bottom wall of the inner pot 20.

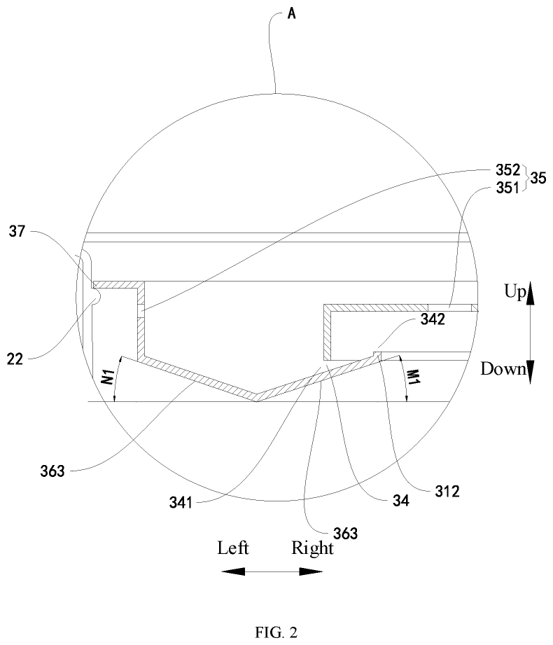

In some embodiments of the present disclosure, as illustrated in FIG. 1 and FIG. 2, the liquid inlet portion 35 further includes a first liquid inlet portion. The flow guide portion 36 further includes a first flow guide portion 362. The first flow guide portion 362 is located at a position corresponding to the first heating element 42 and extends towards the first liquid inlet portion from bottom to top.

The first heating element 42 may directly heat the liquid below the first flow guide portion 362. The bubbles generated by heating the liquid flow upwards to the first flow guide portion 362, and then flow to the first liquid inlet portion along the first flow guide portion 362. In this way, the bubbles can be prevented from being accumulated below the first flow guide portion 362. As a result, it is possible to prevent the bubbles from driving the separation device 30 to fluctuate, thereby avoiding the influence on the position of the separation device 30. Therefore, the separation device 30 can smoothly separate the liquids of different densities.

Meanwhile, when the first heating element 42 heats the liquid below the first flow guide portion 362, the liquid below the first flow guide portion 362 may be quickly boiled. The boiled liquid flows to the backflow channel 34 from the first liquid flowing portion 341 and then flows into the liquid storage cavity 33 from the first liquid inlet portion. The liquid of the high density in the liquid cavity flows into the backflow channel 34 from the first liquid flowing portion 341 and then flows into the liquid storage cavity 33 from the second liquid flowing portion 342 along the backflow channel 34. Therefore, the liquids of different densities in the inner pot 20 can be quickly separated. As a result, the liquid of the high density is stored in the cooking cavity 21, and the liquid of the low density is stored in the liquid storage cavity 33.

In an exemplary embodiment of the present disclosure, the first flow guide portion 362 and the second flow guide portion 361 can guide the liquids and bubbles at different regions. In this way, flow guide efficiency of the flow guide portion 36 is improved. As a result, the liquid in the cooking cavity 21 can quickly flow into the liquid storage cavity 33 through the first liquid inlet portion and the second liquid inlet portion 351. Therefore, the liquid of the high density in the liquid storage cavity 33 flows into the backflow channel 34 from the first liquid flowing portion 341, and then flows into the liquid storage cavity 33 from the second liquid flowing portion 342 along the backflow channel 34. In this way, the liquid of the high density is stored in the cooking cavity 21, and the liquid of the low density is stored in the liquid storage cavity 33. In this way, the efficiency of separating the liquids of different densities is improved. Therefore, the oil in the meat soup can be quickly separated from the meat soup.

The liquid inlet portion 35 further includes a second liquid inlet portion 351. The flow guide portion 36 includes a second flow guide portion 361. The second flow guide portion 361 is located at a position corresponding to the second heating element 41 and extends towards the second liquid inlet portion 351 from bottom to top.

The second heating element 41 may directly heat the liquid below the second flow guide portion 361. The bubbles generated by heating the liquid flow upwards to the second flow guide portion 361 and flow to the second liquid inlet portion 351 along the second flow guide portion 361. In this way, the bubbles can be prevented from being accumulated below the second flow guide portion 361. As a result, it is possible to prevent the bubbles from driving the separation device 30 to fluctuate, thereby avoiding the influence on the position of the separation device 30. Therefore, the separation device 30 can smoothly separate the liquids of different densities.

Meanwhile, when the second heating element 41 heats the liquid below the second flow guide portion 361, the liquid below the second flow guide portion 361 may be quickly boiled. The boiled liquid flows to the second liquid inlet portion 351 along the second flow guide portion 361, and then flows into the liquid storage cavity 33 from the second liquid inlet portion 351. The liquid of high density in the liquid cavity flows into the backflow channel 34 from the first liquid flowing portion 341, and then flows into the liquid storage cavity 33 from the second liquid flowing portion 342 along the backflow channel 34. Therefore, the liquids of different densities in the inner pot 20 can be quickly separated. As a result, the liquid of the high density is stored in the cooking cavity 21, and the liquid of the low density is stored in the liquid storage cavity 33.

In some exemplary embodiments of the present disclosure, the first flow guide portion 362 and the second flow guide portion 361 are each of an annular structure. The first flow guide portion 362 is located outside the second flow guide portion 361. In this way, the first flow guide portion 362 and the second flow guide portion 361 can heat the liquids at different regions in the cooking cavity 21. Further, quickly heating the liquid in the cooking cavity 21 is facilitated, thereby allowing the liquid in the cooking cavity 21 to be quickly boiled. The boiled liquid may flow into the liquid storage cavity 33 from the second liquid inlet portion 351 along the second flow guide portion 361, and flow into the liquid storage cavity 33 along the first liquid inlet portion. Furthermore, the cooking appliance 1 can quickly separate the liquids of different densities. Therefore, the cooking appliance 1 can quickly separate the oil from the meat soup.

In some embodiments, the first flow guide portion 362 is located at a position corresponding to the first heating element 42. The first heating element 42 can heat the liquid at the side of the cooking cavity 21, thereby allowing the liquid at the side of the cooking cavity 21 to flow into the first liquid inlet portion along the first flow guide portion 362 and to flow into the liquid storage cavity 33 from the first liquid inlet portion. The second flow guide portion 361 is located at a position corresponding to the second heating element 41. The second heating element 41 can heat the liquid in the middle of the cooking cavity 21, thereby allowing the liquid in the middle of the cooking cavity 21 to flow to the second liquid inlet portion 351 along the second flow guide portion 361 and then to flow into the liquid storage cavity 33 from the second liquid inlet portion 351.

In some exemplary embodiments of the present disclosure, as illustrated in FIG. 2, both the first flow guide portion 362 and the second flow guide portion 361 extend away from each other from bottom to top, thereby allowing the first flow guide portion 362 and the second flow guide portion 361 to guide the liquids at different regions in the cooking cavity 21, respectively. In an exemplary embodiment of the present disclosure, the liquid located near the first flow guide portion 362 in the cooking cavity 21 may flow upwards to the first liquid inlet portion along the first flow guide portion 362 and then flow into the liquid storage cavity 33 from the first liquid inlet portion. In addition, the liquid located near the second flow guide portion 361 in the cooking cavity 21 may flow upwards to the second liquid inlet portion 351 along the second flow guide portion 361 and then flow into the liquid storage cavity 33 from the second liquid inlet portion 351.

Both the first flow guide portion 362 and the second flow guide portion 361 extend away from each other from bottom to top to prevent the first flow guide portion 362 and the second flow guide portion 361 from interfering with each other. In this way, flow guide efficiency of the liquid in the cooking cavity 21 by the first flow guide portion 362 and the second flow guide portion 361 is improved. Therefore, the liquid in the cooking cavity 21 can flow to the second liquid inlet portion 351 along the second flow guide portion 361 and then flow into the liquid storage cavity 33 from the second liquid inlet portion 351. In addition, the liquid in the cooking cavity 21 can flow to the first liquid inlet portion along the first flow guide portion 362 and then flow into the liquid storage cavity 33 from the first liquid inlet portion.

Meanwhile, both the first flow guide portion 362 and the second flow guide portion 361 extend away from each other from bottom to top. In this way, a depth of and a liquid storage capacity of the liquid storage cavity 33 are increased. Further, more oil can be stored in the liquid storage cavity 33 when the oil in the cooking cavity 21 is separated. Therefore, the oil is prevented from flowing into the cooking cavity 21 from the liquid inlet portion 35.

As illustrated in FIG. 1 and FIG. 2, in some embodiments, the separation device 30 defines an annular liquid storage cavity 33 and an annular backflow channel 34. The first flow guide portion 362 is located outside the second flow guide portion 361. The first flow guide portion 362 extends away from the axis of the cooking cavity 21 from bottom to top. The first liquid inlet portion is disposed at the side part of the separation device 30. The first liquid inlet portion is located outside the second liquid inlet portion 351. The liquid at the side of the cooking cavity 21 may flow upwards to the first liquid inlet portion along the first flow guide portion 362 and then smoothly flow into the liquid storage cavity 33 from the first liquid inlet portion.

The second flow guide portion 361 extends towards the axis of the cooking cavity 21 from bottom to top. The second liquid inlet portion 351 is disposed at a top of the separation device 30. The liquid in the middle of the cooking cavity 21 may flow upwards to the second liquid inlet portion 351 along the second flow guide portion 361 and then smoothly flow into the liquid storage cavity 33 from the second liquid inlet portion 351.

In some exemplary embodiments of the present disclosure, the first flow guide portion 362 includes an inclined flow guide surface 363 and/or an arc flow guide surface 364. When the liquid in the cooking cavity 21 is boiled, the boiled liquids and bubbles near the first flow guide portion 362 may flow to the first liquid inlet portion along the inclined flow guide surface 363 and/or the arc flow guide surface 364 and then flow into the liquid storage cavity 33 from the first liquid inlet portion. On the one hand, the liquid in the cooking cavity 21 can quickly flow into the liquid storage cavity 33 along the inclined flow guide surface 363 and/or the arc flow guide surface 364. On the other hand, the bubbles can be prevented from being accumulated at the bottom of the separation device 30. As a result, it is possible to prevent the bubbles from driving the separation device 30 to fluctuate, thereby avoiding the influence on the position of the separation device 30. Therefore, the separation device 30 can smoothly separate the liquids of different densities.

In some embodiments, as illustrated in FIG. 2, the first flow guide portion 362 includes the inclined flow guide surface 363. An angle between the inclined flow guide surface 363 and the horizontal plane is denoted as N1, and N1 ranges from 10° to 60°. In this way, the first flow guide portion 362 can guide the liquid in the cooking cavity 21 to the first liquid inlet portion. Further, the liquid in the cooking cavity 21 can flow into the liquid storage cavity 33 quickly and smoothly. Therefore, the liquids of different densities in the inner pot 20 can be quickly separated. As a result, the liquid of the high density is stored in the cooking cavity 21, and the liquid of the low density is stored in the liquid storage cavity 33.

The angle N1 between the inclined flow guide surface 363 on the first flow guide portion 362 and the horizontal plane is 10°, 20°, 30°, 45°, 50°, or 60°. In this way, the first flow guide portion 362 can better guide the liquid in the cooking cavity 21. Therefore, the liquid in the cooking cavity 21 can flow into the liquid storage cavity 33 along the inclined flow guide surface 363 quickly and smoothly.

In other embodiments, as illustrated in FIG. 4, the first flow guide portion 362 includes an arc flow guide surface 364. The arc flow guide surface 364 is a convex surface. In this way, the liquid in the cooking cavity 21 can smoothly flow into the liquid storage cavity 33 along the convex surface, thereby preventing the liquid near the first liquid inlet portion from being accumulated at the convex surface. Therefore, the liquid in the cooking cavity 21 can flow to the second liquid inlet portion 351 along the arc flow guide surface 364. Therefore, the liquid in the cooking cavity 21 can quickly and smoothly flow into the liquid storage cavity 33 along the inclined flow guide surface 363.

In some exemplary embodiments of the present disclosure, the second flow guide portion 361 includes an inclined flow guide surface 363 and/or an arc flow guide surface 364. When the liquid in the cooking cavity 21 is boiled, the liquids and bubbles near the second flow guide portion 361 may flow to the second liquid inlet portion 351 along the inclined flow guide surface 363 and/or the arc flow guide surface 364 and then flow into the liquid storage cavity 33 from the second liquid inlet portion 351. On the one hand, the liquid in the cooking cavity 21 can quickly flow into the liquid storage cavity 33 along the inclined flow guide surface 363 and/or the arc flow guide surface 364. On the other hand, the bubbles can be prevented from being accumulated at the bottom of the separation device 30. As a result, it is possible to prevent the bubbles from driving the separation device 30 to fluctuate, thereby avoiding the influence on the position of the separation device 30. Therefore, the separation device 30 can smoothly separate the liquids of different densities.

In some embodiments, as illustrated in FIG. 2, the second flow guide portion 361 includes an inclined flow guide surface 363. An angle between the inclined flow guide surface 363 and the horizontal plane is denoted as M1, and M1 ranges from 10° to 60°. In this way, the second flow guide portion 361 can guide the liquid in the cooking cavity 21 to the second liquid inlet portion 351. Therefore, the liquid in the cooking cavity 21 can quickly and smoothly flow into the liquid storage cavity 33. As a result, the liquid of the high density is stored in the cooking cavity 21, and the liquid of the low density is stored in the liquid storage cavity 33.

The angle M1 between the inclined flow guide surface 363 on the second flow guide portion 361 and the horizontal plane is 10°, 20°, 30°, 45°, 50°, or 60°. In this way, the second flow guide portion 361 can better guide the liquid in the cooking cavity 21. Therefore, the liquid in the cooking cavity 21 can quickly and smoothly flow into the liquid storage cavity 33 along the inclined flow guide surface 363.

In other embodiments, as illustrated in FIG. 4, the second flow guide portion 361 includes an arc flow guide surface 364. The arc flow guide surface 364 is a convex surface. In this way, the liquid in the cooking cavity 21 can smoothly flow into the liquid storage cavity 33 along the convex surface, thereby preventing the liquid near the second flow guide portion 361 from being accumulated at the convex surface. Therefore, the liquid in the cooking cavity 21 can flow to the second liquid inlet portion 351 along the arc flow guide surface 364. As a result, the liquid in the cooking cavity 21 can quickly and smoothly flow into the liquid storage cavity 33 along the inclined flow guide surface 363.

In some examples, as illustrated in FIG. 2, the first flow guide portion 362 includes an inclined flow guide surface 363. The first flow guide portion 362 obliquely extends upwards from right to left. The liquid in the cooking cavity 21 may flow to the first liquid inlet portion along the first flow guide portion 362 from right to left and then flow into the liquid storage cavity 33 from the first liquid inlet portion. The second flow guide portion 361 includes the inclined flow guide surface 363. The second flow guide portion 361 obliquely extends upwards from left to right. The liquid in the cooking cavity 21 may flow to the second liquid inlet portion 351 along the second flow guide portion 361 from left to right and then flow into the liquid storage cavity 33 from the second liquid inlet portion 351.

A left end of the second flow guide portion 361 is connected to a right end of the first flow guide portion 362. In this way, a depth of the liquid storage cavity 33 in the up-down direction can be increased, and the liquid storage capacity of the liquid storage cavity 33 can be improved. Further, more oil can be stored in the liquid storage cavity 33 when the oil in the cooking cavity 21 is separated. Therefore, the oil is prevented from flowing into the cooking cavity 21 from the liquid inlet portion 35.

In some other examples, as illustrated in FIG. 4, the first flow guide portion 362 includes the arc flow guide surface 364. The second flow guide portion 361 includes the arc flow guide surface 364. The arc flow guide surface 364 of each of the first flow guide portion 362 and the second flow guide portion 361 is a convex surface. The first flow guide 362 extends upwards from right to left. The liquid in the cooking cavity 21 may flow to the first liquid inlet portion along the first flow guide portion 362 from right to left and then flow into the liquid storage cavity 33 from the first liquid inlet portion. The second flow guide portion 361 extends upwards from the left to the right. The liquid in the cooking cavity 21 can flow to the second liquid inlet 351 along the second flow guide portion 361 from left to right and then flow into the liquid storage cavity 33 from the second liquid inlet portion 351.

The left end of the second flow guide portion 361 is connected to the right end of the first flow guide portion 362 to form an arc surface protruding downwards. In this way, the depth of the liquid storage cavity 33 in the up-down direction can be increased, and the liquid storage capacity of the liquid storage cavity 33 can be improved. Further, when the oil in the cooking cavity 21 is separated, more oil can be stored in the liquid storage cavity 33, thereby preventing the oil from flowing into the cooking cavity 21 from the liquid inlet portion 35. It should be understood that the above-mentioned directions are limited only to facilitate the description of the drawings, and do not limit an actual arrangement position and orientation of the cooking appliance 1.

In some examples, the first flow guide portion 362 includes an inclined flow guide surface 363, and the second flow guide portion 361 includes an arc flow guide surface 364. In another embodiment of the present disclosure, the first flow guide portion 362 may include an arc flow guide surface 364, and the second flow guide portion 361 may include an inclined flow guide surface 363.

In some embodiments of the present disclosure, the separation device 30 includes a liquid storage container 31 and an oil blocking member 32. The liquid storage container 31 is disposed in the cooking cavity 21.

In some embodiments, the backflow channel 34 is defined by the oil blocking member 32 and the liquid storage container 31. The first flow guide portion 362 and the second flow guide portion 361 are provided at the outer surface of the bottom wall of the liquid storage container 31.

When the liquid in the cooking cavity 21 is boiled, the liquid near the first flow guide portion 362 located at the outer surface of the bottom wall of the liquid storage container 31 may flow to the first liquid inlet portion along the first flow guide portion 362 and then flow into the liquid storage cavity 33 from the first liquid inlet portion, and the liquid near the second flow guide portion 361 located at the outer surface of the bottom wall of the liquid storage container 31 may flow to the second liquid inlet portion 351 along the second flow guide portion 361 and then flow into the liquid storage cavity 33 from the second liquid inlet portion 351. Further, the liquid of the high density in the liquid storage cavity 33 may flow into the backflow channel 34 from the first liquid flowing portion 341 and then flow into the cooking cavity 21 from the first liquid inlet portion along the backflow channel 34, and the liquid of the low density is left in the liquid storage cavity 33. As a result, the liquids of different densities in the cooking cavity 21 can be separated from each other. Therefore, when the cooking appliance 1 is cooking soup, the oil in the meat soup can be separated.

Meanwhile, bubbles located at the bottom wall of the liquid storage container 31 can flow to the second liquid inlet portion 351 along the second flow guide portion 361 and then flow to the first liquid inlet portion along the first flow guide portion 362. Therefore, the bubbles can be prevented from being accumulated at the outer surface of the bottom wall of the liquid storage container 31. As a result, it is possible to prevent the bubble from driving the liquid storage container 31 to fluctuate, thereby avoiding the influence on the position of the liquid storage container 31 and the position of the oil blocking member 32. In this way, the separation device 30 can smoothly separate the liquids of different densities.

In some other embodiments, as illustrated in FIG. 5, the oil blocking member 32 is disposed outside the liquid storage container 31. The first flow guide portion 362 and the second flow guide portion 361 are disposed at the oil blocking member 32. The backflow channel 34 is defined by the oil blocking member 32 and an outer side wall of the liquid storage container 31.

When the liquid in the cooking cavity 21 is boiled, the liquid near the first flow guide portion 362 located at the outer surface of the bottom wall of the oil blocking member 32 may flow to the first liquid inlet portion along the first flow guide portion 362 and then flow into the liquid storage cavity 33 from the first liquid inlet portion, and the liquid near the second flow guide portion 361 located at the outer surface of the bottom wall of the oil blocking member 32 may flow to the second liquid inlet portion 351 along the second flow guide portion 361 and then flow into the liquid storage cavity 33 from the second liquid inlet portion 351. Further, the liquid of the high density in the liquid storage cavity 33 may flow into the backflow channel 34 from the first liquid flowing portion 341 and then flow into the cooking cavity 21 from the first liquid inlet portion along the backflow channel 34, and the liquid of the low density is left in the liquid storage cavity 33. As a result, the liquids of different densities in the cooking cavity 21 can be separated. Therefore, when the cooking appliance 1 is cooking soup, the oil in the meat soup can be separated.

Meanwhile, the bubbles located at the bottom wall of the oil blocking member 32 may flow to the first liquid inlet portion along the first flow guide portion 361 and then flow to the second liquid inlet portion 351 along the second flow guide portion 361. Therefore, the bubbles can be prevented from being accumulated at the outer surface of the bottom wall of the oil blocking member 32. As a result, the bubbles can be prevented from driving the oil blocking member 32 to fluctuate, thereby avoiding the influence on the position of the liquid storage container 31 and the position of the oil blocking member 32. In this way, the separation device 30 can smoothly separate the liquids of different densities.

As illustrated in FIG. 1, in the embodiment, the separation device 30 is disposed above the cooking cavity 21. When the liquid in the cooking cavity 21 is boiled, the bottom wall of the separation device 30 can easily block the boiling of the liquid above the cooking cavity 21. Therefore, the first flow guide portion 362 and the second flow guide portion 361 are disposed at the outer surface of the bottom wall of the separation device 30, thereby allowing the liquid below the bottom wall of the separation device 30 to flow to the second liquid inlet portion 351 along the second flow guide portion 361 and then flow to the first liquid inlet portion along the first flow guide portion 362. Therefore, the bottom wall of the separation device 30 is prevented from blocking the flowing of the liquid in the cooking cavity 21. In this way, the liquid in the cooking cavity 21 can smoothly flow into the liquid storage cavity 33, and thus the liquids of different densities in the cooking cavity 21 can be smoothly separated.

Meanwhile, when the liquid in the cooking cavity 21 is boiled and the bubbles generated in the cooking cavity 21 move upwards to the outer surface of the bottom wall of the separation device 30, the bubbles may flow to the second liquid inlet portion 351 along the second flow guide portion 361 from bottom to top and then flow upwards to the first liquid inlet portion along the first flow guide portion 362. As a result, the bubbles can be prevented from being accumulated at the outer surface of the bottom wall of the separation device 30. As a result, it is possible to prevent the bubbles from driving the separation device 30 to fluctuate when the bubbles fluctuate, thereby avoiding the influence on the position of the separation device 30. Therefore, the separation device 30 can smoothly separate the liquids of different densities.

In some embodiments, in some embodiments, the first liquid inlet portion includes a first liquid inlet 352. The first liquid inlet 352 is formed at a peripheral wall of the liquid storage container 31. When the liquid in the cooking cavity 21 is boiled, the liquid at the side of the cooking cavity 21 may flow upwards to the peripheral wall of the liquid storage container 31 along the first flow guide portion 362, and the liquid located outside the liquid storage cavity 33 may flow into the liquid storage cavity 33 from the first liquid inlet 352 at the peripheral wall of the liquid storage container 31. Further, the liquid of the high density in the liquid storage cavity 33 may flow into the backflow channel 34 from the first liquid flowing portion 341 and then flows into the liquid storage cavity 33 from the second liquid flowing portion 342 along the backflow channel 34. Therefore, the liquids of different densities in the inner pot 20 can be separated. In this way, the liquid of the high density is stored in the cooking cavity 21, and the liquid of the low density is stored in the liquid storage cavity 33.

In some other embodiments, the first liquid inlet portion includes an upper opening formed at the peripheral wall of the liquid storage container 31. When the liquid in the cooking cavity 21 is boiled, the liquid at the side of the cooking cavity 21 may flow to the upper opening at the peripheral wall of the liquid storage container 31 along the first flow guide portion 362, and the liquid located outside the liquid storage cavity 33 may flow into the liquid storage cavity 33 from the first liquid inlet portion at the upper opening at the peripheral wall of the liquid storage container 31. Further, the liquid of the high density in the liquid storage cavity 33 may flow into the backflow channel 34 from the first liquid flowing portion 341 and then flows into the liquid storage cavity 33 from the second liquid flowing portion 342 along the backflow channel 34. Therefore, the liquids of different densities in the inner pot 20 can be separated. As a result, the liquid of the high density is stored in the cooking cavity 21, and the liquid of the low density is stored in the liquid storage cavity 33.

As illustrated in FIG. 4, in the embodiment, the oil blocking member 32 is at least partially disposed in the liquid storage container 31. The first flow guide portion 362 is provided at the outer surface of the bottom wall of the liquid storage container 31. The liquid storage container 3 has a first liquid inlet 35 formed at the peripheral wall of the liquid storage container 31. When the liquid in the cooking cavity 21 is boiled, the liquid at the side of the cooking cavity 21 may flow upwards to the peripheral wall of the liquid storage container 31 along the first flow guide portion 362, and the liquid located outside the liquid storage cavity 33 may flow into the liquid storage cavity 33 from the first liquid inlet 352 at the peripheral wall of the liquid storage container 31 or the upper opening at the peripheral wall of the liquid storage container 31.

As illustrated in FIG. 5, in the embodiment, the oil blocking member 32 is disposed outside the liquid storage container 31. The first flow guide portion 362 is disposed at the outer surface of the bottom wall of the oil blocking member 32. The liquid storage container 3 has a first liquid inlet 35 formed at the peripheral wall of the liquid storage container 31. When the liquid in the cooking cavity 21 is boiled, the liquid at the side of the cooking cavity 21 may flow upwards to the peripheral wall of the liquid storage container 31 along the first flow guide portion 362, and the liquid located outside the liquid storage cavity 33 may flow into the liquid storage cavity 33 from the first liquid inlet 352 at the peripheral wall of the liquid storage container 31 or from the upper opening at the peripheral wall of the liquid storage container 31.

In some exemplary embodiments of the present disclosure, as illustrated in FIG. 4 and FIG. 5, the first liquid inlet portion includes first liquid inlets 352. The first liquid inlets 352 is formed at the peripheral wall of the liquid storage container 31. In this way, when the liquid in the cooking cavity 21 is boiled, the liquid near the first flow guide portion 362 may flow to the first liquid inlets 352 along the first flow guide portion 362, and thus the liquid can quickly flow into the liquid storage cavity 33 through the liquid inlets.

A total area of the first liquid inlets 352 is greater than or equal to 20 mm², to ensure a speed of the liquid flowing into the liquid storage cavity 33 from the first liquid inlets 352. In this way, the liquid in the cooking cavity 21 can quickly flow into the liquid storage cavity 33 from the first liquid inlets 352. Therefore, the cooking appliance 1 can quickly separate the liquids of different densities.

For example, during the soup cooking of the cooking appliance 1, when the meat soup in the cooking cavity 21 is boiled, the meat soup near the first flow guide portion 362 may flow into the liquid storage cavity 33 from the second liquid inlets along the first flow guide portion 362. In this way, the total area of the first liquid inlets 352 is greater than or equal to 20 mm², thereby preventing the oil from blocking the first liquid inlets 352. Therefore, a speed of the meat soup flowing into the liquid storage cavity 33 through the first liquid inlet 352 is ensured.

The total area of the first liquid inlet 352 may be 20 mm², 22 mm², 25 mm², 30 mm², 35 mm², and 40 mm².

The second liquid inlet portion 351 is disposed on the oil blocking member 32 or the liquid storage container 31. When the liquid in the cooking cavity 21 is boiled, the liquid in the middle of the cooking cavity 21 may flow into the liquid storage cavity 33 from the second liquid inlet portion 351. In this way, the separation device 30 can separate the liquids of different densities in the cooking cavity 21. As a result, the liquid of the high density is stored in the cooking cavity 21, and the liquid of the low density is stored in the liquid storage cavity 33.

In some exemplary embodiments of the present disclosure, as illustrated in FIG. 1 and FIG. 2, the liquid storage container 31 has a bottom wall and a peripheral wall. The liquid storage container 31 has a liquid passing opening 311 formed at a middle part of the bottom wall of the liquid storage container 31. The oil blocking member 32 is disposed in the liquid storage container 31 and covers the liquid passing opening 311. The second liquid inlet portion 351 is disposed at the oil blocking member 32 and faces towards the liquid passing opening 311.

When the liquid in the cooking cavity 21 is boiled, the liquid in the middle of the cooking cavity 21 may flow to the second liquid inlet portion 351 from the liquid passing opening 311 in the middle of the bottom wall of the liquid storage container 31 and then flow into the liquid storage cavity 33 from the second liquid inlet portion 351. In this way, the separation device 30 can separate the liquids of different densities. As a result, the liquid of the high density is stored in the cooking cavity 21, and the liquid of the low density is stored in the liquid storage cavity 33.

In some embodiments, the second flow guide portion 361 extends towards the second liquid inlet portion 351 from bottom to top. The liquid in the middle of the cooking cavity 21 may flow to the second liquid inlet portion 351 from the liquid passing opening 311 along the second flow guide portion 361 from bottom to top, and then flow into the liquid storage cavity 33 from the second liquid inlet portion 351. The liquid of the high density in the liquid storage cavity 33 may flow into the backflow channel 34 from the first liquid flowing portion 341 and then flow into the cooking cavity 21 from the second liquid flowing portion 342 along the backflow channel 34. Therefore, the liquids of different densities in the inner pot 20 can be separated. As a result, the liquid of the high density is stored in the cooking cavity 21, and the liquid of the low density is stored in the liquid storage cavity 33.

Meanwhile, when the liquid in the cooking cavity 21 is boiled and the bubbles generated in the cooking cavity 21 move upwards to the outer surface of the bottom wall of the liquid storage container 31, the bubbles may flow to the second liquid inlet portion 351 along the second flow guide portion 361 from bottom to top. Therefore, the bubbles can be prevented from being accumulated at the outer surface of the bottom wall of the liquid storage container 31. As a result, it is possible to prevent the bubbles from driving the liquid storage container 31 to fluctuate when the bubbles fluctuate, thereby avoiding the influence on the position of the liquid storage container 31 and the position of the oil blocking member 32. Therefore, the separation device 30 can smoothly separate the liquids of different densities.

For example, during the soup cooking of the cooking appliance 1, the meat soup in the cooking cavity 21 flows to the second liquid inlet portion 351 from the liquid passing opening 311 along the second flow guide portion 361 from bottom to top, and then flows into the liquid storage cavity 33 from the second liquid inlet portion 351. The liquid of the high density in the liquid storage cavity 33 flows into the backflow channel 34 from the first liquid flowing portion 341 and flows into the cooking cavity 21 from the second liquid flowing portion 342 along the backflow channel 34. Therefore, the oil of the low density in the meat soup is stored in the liquid storage cavity 33, allowing for the separation of the oil from the meat soup. In this way, palatability of the meat soup can be improved. In one embodiment, health-conscious preference for low-fat diets is satisfied. In addition, diet healthiness of the user can be enhanced.

In some embodiments, as illustrated in FIG. 1 and FIG. 2, the bottom wall of the liquid storage container 31 has an annular flange 312 extending upwards. The liquid passing opening 311 is formed by an upper opening of the annular flange 312. The oil blocking member 32 has a top wall and a peripheral wall. The second liquid inlet portion 351 is disposed at the top wall of the oil blocking member 32. The annular flange 312 may guide the liquid in the cooking cavity 21 to flow to the liquid passing opening 311. In this way, the liquid in the middle of the cooking cavity 21 may flow upwards to the second liquid inlet portion 351 from the liquid passing opening 311 along the annular flange 312 and then flow into the liquid storage cavity 33 from the second liquid inlet portion 351. The liquid of the high density in the liquid storage cavity 33 flows into the backflow channel 34 from the first liquid flowing portion 341, and then flows into the liquid storage cavity 33 from the second liquid flowing portion 342 along the backflow channel 34. Therefore, the liquids of different densities in the inner pot 20 can be separated. As a result, the liquid of the high density is stored in the cooking cavity 21, and the liquid of the low density is stored in the liquid storage cavity 33.

The peripheral wall of the oil blocking member 32 is located outside the annular flange 312. The backflow channel 34 is at least partially defined by the annular flange 312 and the peripheral wall of the oil blocking member 32. In this way, the liquid of the high density in the liquid storage cavity 33 may flow into the cooking cavity 21 along the backflow channel 34. In one embodiment, the liquid of the low density in the liquid storage cavity 33 may be stored in the liquid storage cavity 33. Therefore, the liquids of different densities in the inner pot 20 can be separated.

Meanwhile, the backflow channel 34 is at least partially defined by the peripheral wall of the oil blocking member 32 and the annular flange 312. In this way, an increase in a height of the second liquid flowing portion 342 is facilitated. Further, the oil storage capacity of the separation device 30 can be improved. Furthermore, the oil can be stored in the backflow channel 34 when the oil in the liquid storage cavity 33 is too much.

As illustrated in FIG. 1, in the embodiment, an annular liquid storage cavity 33 is defined by the liquid storage container 31 and the peripheral wall of the oil blocking member 32. The annular flange 312 extends in the up-down direction. An annular liquid passing opening 311 is defined by the annular flange 312. The liquid in the middle of the cooking cavity 21 may flow into the annular liquid storage cavity 33 upwards from the second liquid inlet portion 351 along the annular flange 312. The liquid of the high density in the liquid storage cavity 33 flows into the backflow channel 34 from the first liquid flowing portion 341, and then flows into the liquid storage cavity 33 from the second liquid flowing portion 342 along the backflow channel 34. Therefore, the liquids of different densities in the inner pot 20 can be separated. In this way, the liquid of the high density is stored in the cooking cavity 21, and the liquid of the low density is stored in the liquid storage cavity 33.

In some embodiments of the present disclosure, as illustrated in FIG. 1 and FIG. 2, the inner pot 20 is provided with a positioning protrusion 22 at a side wall of the inner pot 20. The separation device 30 is provided with a support edge 37. The support edge 37 is engaged with the positioning protrusion 22. In this way, the support edge 37 is supported by using the positioning protrusion 22. Further, the separation device 30 is supported in the inner pot 20, thereby allowing the liquid in the cooking cavity 21 to flow into the liquid storage cavity 33 from the liquid inlet portion 35. The liquid of the high density in the liquid storage cavity 33 may flow into the backflow channel 34 from the first liquid flowing portion 341 and then flow into the cooking cavity 21 from the second liquid flowing portion 342 along the backflow channel 34. The liquid of the low density is left in the liquid storage cavity 33. As a result, the liquids of different densities in the cooking cavity 21 are separated from each other. Therefore, when the cooking appliance 1 is cooking soup, the oil in the meat soup can be separated.

In some embodiments of the present disclosure, the separation device 30 is provided with a protruding rib at a side wall of the separation device 30. The protruding rib is engaged with the side wall of the inner pot 20. In this way, the separation device 30 is disposed in the inner pot 20, thereby allowing the liquid in the cooking cavity 21 to flow into the liquid storage cavity 33 from the liquid inlet portion 35. The liquid of the high density in the liquid storage cavity 33 may flow into the backflow channel 34 from the first liquid flowing portion 341, and then flow into the cooking cavity 21 from the second liquid flowing portion 342 along the backflow channel 34. The liquid of the low density is left in the liquid storage cavity 33. As a result, the liquids of different densities in the cooking cavity 21 are separated from each other. Therefore, when the cooking appliance 1 is cooking soup, the oil in the meat soup can be separated.

In some embodiments of the present disclosure, the separation surface 30 is supported at an edge of the inner pot 20. In this way, the separation device 30 is disposed in the inner pot 20, thereby allowing the liquid in the cooking cavity 21 to flow into the liquid storage cavity 33 from the liquid inlet portion 35. The liquid of the high density in the liquid storage cavity 33 may flow into the backflow channel 34 from the first liquid flowing portion 341 and then flow into the cooking cavity 21 from the second liquid flowing portion 342 along the backflow channel 34. The liquid of the low density is left in the liquid storage cavity 33. As a result, the liquids of different densities in the cooking cavity 21 are separated from each other. Therefore, when the cooking appliance 1 is cooking soup, the oil in the meat soup can be separated.

In some embodiments of the present disclosure, the separation device 30 is supported at the bottom wall of the inner pot 20. In this way, the separation device 30 is disposed in the inner pot 20, thereby allowing the liquid in the cooking cavity 21 to flow into the liquid storage cavity 33 from the liquid inlet portion 35. The liquid of the high density in the liquid storage cavity 33 may flow into the backflow channel 34 from the first liquid flowing portion 341 and flow into the cooking cavity 21 from the second liquid flowing portion 342 along the backflow channel 34. The liquid of the low density is left in the liquid storage cavity 33. As a result, the liquids of different densities in the cooking cavity 21 are separated from each other. Therefore, when the cooking appliance 1 is cooking soup, the oil in the meat soup can be separated.

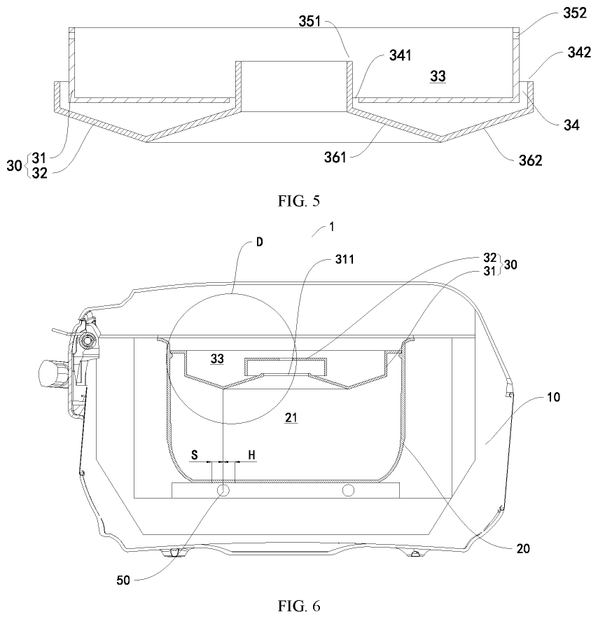

As illustrated in FIG. 6 to FIG. 12, the cooking appliance 1 according to an embodiment of the present disclosure includes a cooking body 10, an inner pot 20, and a separation device 30.

The cooking body 10 defines an accommodation cavity. The inner pot 20 is provided in the accommodation cavity. The inner pot 20 defines a cooking cavity 21. The user may place food materials in the cooking cavity 21, and thus the food materials in the cooking cavity 21 can be cooked by the cooking appliance 1. The separation device 30 is provided in the inner pot 20. The separation device 30 has a liquid storage cavity 33 and a backflow channel 34. The backflow channel 34 has a first liquid flowing portion 341 and a second liquid flowing portion 342. The liquid storage cavity 33 is in communication with the backflow channel 34 through the first liquid flowing portion 341. The cooking cavity 21 is in communication with the backflow channel 34 through the second liquid flowing portion 342. The second liquid flowing portion 342 is disposed above the first liquid flowing portion 341. The separation device 30 has a liquid inlet portion 35, and the liquid storage cavity 33 is in communication with the cooking cavity 21 through the liquid inlet portion 35.

After the liquid in the cooking cavity 21 flows into the liquid storage cavity 33 from the liquid inlet portion 35, the liquid of the low density floats at a position above the liquid storage cavity 33. In one embodiment, the liquid of the high density is accumulated below the liquid storage cavity 33. The liquid of the high density at the lower part of the liquid storage cavity 33 may flow into the backflow channel 34 from the first liquid flowing portion 341. As the liquid level rises within the liquid storage cavity 33, the liquid of the high density in the backflow channel 34 may flow into the cooking cavity 21 from the second liquid flowing portion 342. In this way, the liquids of different densities in the inner pot 20 can be separated from each other. Therefore, the liquid of the low density can be accumulated in the liquid storage cavity 33, and the liquid of the high density can be accumulated in the cooking cavity 21.

In addition, after the liquid of the high density flows into the backflow channel 34 from the first liquid flowing portion 341 and then flows into the cooking cavity 21 from the second liquid flowing portion 342 along the backflow channel 34, the liquid of the low density is accumulated in the liquid storage cavity 33. In this way, the second liquid flowing portion 342 is allowed to be located above the first liquid flowing portion 341. Therefore, the liquid of the low density can be stored in the liquid storage cavity 33, to avoid the flow of the liquid of the low density into the cooking cavity 21.

The separation device 30 is provided with the flow guide portion 36 at the bottom of the separation device 30. The flow guide portion 36 is configured to guide the liquid in the cooking cavity 21 to flow towards the liquid inlet portion 35. When the liquid in the cooking cavity 21 is boiled, the flow guide portion 36 can guide the liquid above the cooking cavity 21 to flow to the liquid inlet portion 35 along the flow guide portion 36. In this way, the liquid in the cooking cavity 21 can quickly flow into the liquid storage cavity 33 from the liquid inlet portion 35 along the flow guide portion 36. Therefore, the efficiency of separating the liquids of different densities by the cooking appliance 1 can be improved. The liquid of the low density is accumulated in the liquid storage cavity 33, and the liquid of the high density is accumulated in the cooking cavity 21.

In addition, by providing the flow guide portion 36 at the bottom of the separation device 30, in a case where the liquid in the cooking cavity 21 is boiled, when the bubbles generated in the cooking cavity 21 move upwards to the bottom of the separation device 30, the bubbles may flow to the liquid inlet portion 35 along the flow guide portion 36 at the bottom of the separation device 30. Therefore, the bubbles can be prevented from being accumulated at the bottom of the separation device 30. As a result, it is possible to prevent the bubbles from driving the separation device 30 to fluctuate, thereby avoiding the influence on the position of the separation device 30. Therefore, the separation device 30 can smoothly separate the liquids of different densities.

In some embodiments, by providing the flow guide portion 36 at the bottom of the separation device 30, when the liquid in the cooking cavity 21 is boiled, the flow guide portion 36 may guide the flow of the liquid, thereby allowing the liquid to flow into the liquid storage cavity 33 from the liquid inlet portion 35. In this way, when the liquids of different densities in the cooking cavity 21 are separated, the reduction in the time for the cooking appliance 1 to separate the oil is facilitated. Therefore, the cooking appliance 1 can flexibly change the heating temperature as required, which makes the cooking appliance 1 better cook the soup.

In some embodiments, during the soup cooking of the cooking appliance 1, during the heating of the meat soup in the cooking cavity 21, when the meat soup in the cooking cavity 21 is boiled, the bubbles and boiled liquids generated by the heating may flow to the liquid inlet portion 35 along the flow guide portion 36. On the one hand, the liquid in the cooking cavity 21 can quickly flow into the liquid storage cavity 33 along the flow guide portion 36. As a result, the oil in the meat soup in the cooking cavity 21 can be quickly and automatically separated by the separation device 30. On the other hand, the bubbles can be prevented from being accumulated at the bottom of the separation device 30. As a result, it is possible to prevent the bubbles from driving the separation device 30 to fluctuate when the bubbles fluctuates, thereby avoiding the influence on the position of the separation device 30. Therefore, the separation device 30 can smoothly separate the liquids of different densities.

In an exemplary embodiment of the present disclosure, after the liquid in the cooking cavity 21 flows into the liquid storage cavity 33 along the flow guide portion 36, the soup of the high density in the liquid storage cavity 33 flows into the backflow channel 34 from the first liquid flowing portion 341 and then flows into the cooking cavity 21 from the second liquid flowing portion 342 along the backflow channel 34. The oil of the low density can be stored in the liquid storage cavity 33. As a result, the oil in the meat soup is separated from the soup. In this way, after the soup cooking is completed, the user can obtain the soup in which the oil has been removed from the cooking cavity 21 without additionally removing the oil from the meat soup in the cooking cavity 21. Therefore, the workload of the user is reduced, and the time and effort of the user are saved. In addition, the efficiency of oil-water separation is improved, and it is convenient to improve the effect of oil-water separation.

Therefore, during the cooking of the cooking appliance 1 according to the embodiments of the present disclosure, the liquid in the cooking cavity 21 can quickly flow into the liquid storage cavity 33 along the flow guide portion 36. As a result, the oil in the meat soup can be quickly and automatically separated. Meanwhile, the flow guide portion 36 can disperse the bubbles at the bottom of the separation device 30, thereby preventing the bubbles from driving the separation device 30 to fluctuate. Therefore, the oil-water separation efficiency can be improved, and the workload of the user can be reduced. In addition, the time and energy of the user can be saved.

A cooking appliance 1 according to an exemplary embodiment of the present disclosure will be described below with reference to the accompanying drawings.

As illustrated in FIG. 6 to FIG. 12, the cooking appliance 1 according to an embodiment of the present disclosure includes a cooking body 10, an inner pot 20, and a separation device 30.

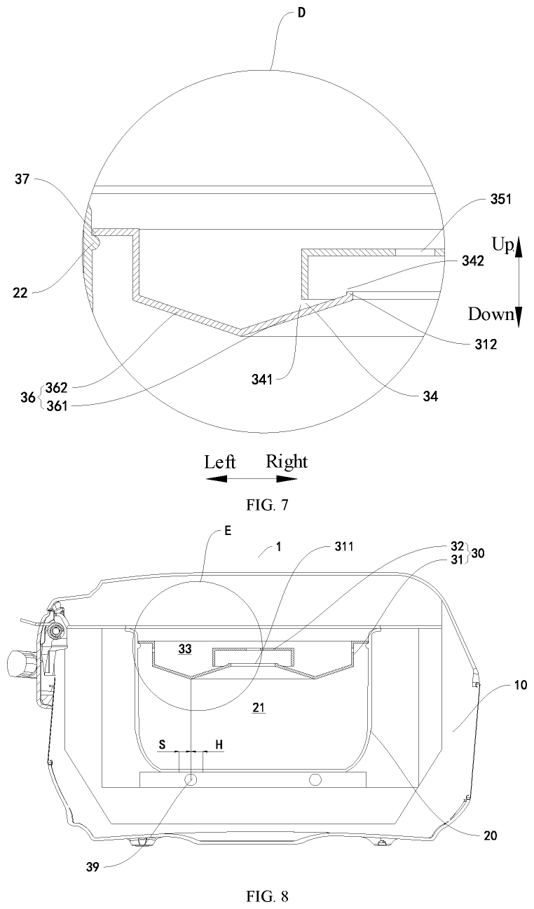

In some embodiments of the present disclosure, as illustrated in FIG. 6 and FIG. 7, the flow guide portion 36 extends towards at least one liquid inlet portion 35 from bottom to top. In this way, when the liquid in the cooking cavity 21 is boiled, the liquid in the cooking cavity 21 may flow to liquid inlet portion 35 along the flow guide portion 36 from bottom to top, and thus the liquid in the cooking cavity 21 can quickly flow into the liquid storage cavity 33 from the liquid inlet portion 35. The improvement of the efficiency of the liquid in the cooking cavity 21 flowing into the liquid storage cavity 33 is facilitated. Therefore, the liquids of different densities in the cooking cavity 21 can be quickly separated. As a result, the liquid of the high density is stored in the cooking cavity 21, and the liquid of the low density is stored in the liquid storage cavity 33.

Meanwhile, when the liquid in the cooking cavity 21 is boiled and the bubbles generated in the cooking cavity 21 move upwards to the bottom of the separation device 30, the bubbles may flow to the liquid inlet portion 35 along the flow guide portion 36 from bottom to top. In this way, the bubbles are prevented from being accumulated at the bottom of the separation device 30. As a result, it is possible to prevent the bubbles from driving the separation device 30 to fluctuate when the bubbles fluctuate, thereby avoiding the influence on the position of the separation device 30. Therefore, the separation device 30 can smoothly separate the liquids with different densities.

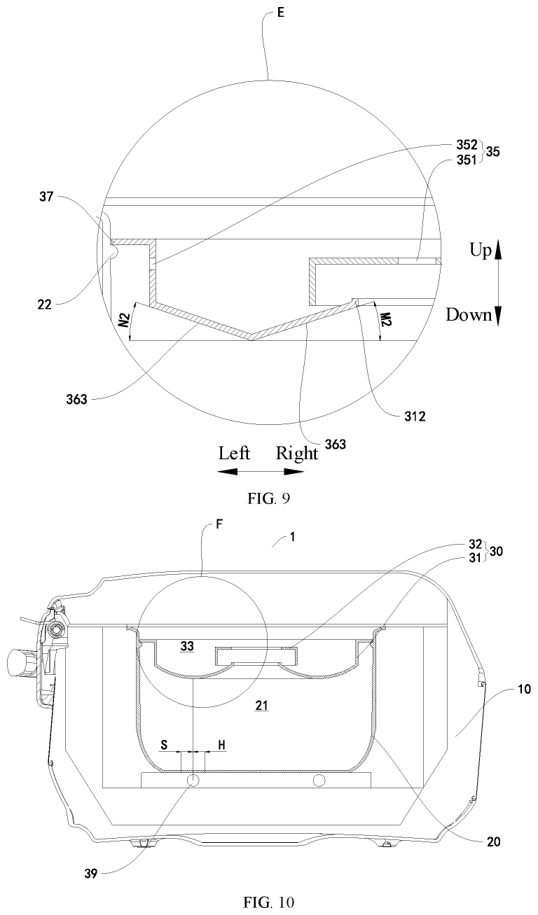

In some embodiments of the present disclosure, as illustrated in FIG. 9, the flow guide portion 36 includes an inclined flow guide surface 363. When the liquid in the cooking cavity 21 is boiled, the bubbles and boiled liquids in the cooking cavity 21 may flow to the liquid inlet portion 35 along the inclined flow guide surface 363 and then flow into the liquid storage cavity 33 from the liquid inlet portion 35. On the one hand, the liquid in the cooking cavity 21 can quickly flow into the liquid storage cavity 33 along the inclined flow guide surface 363. The improvement in the efficiency of the liquid in the cooking cavity 21 flowing into the liquid storage cavity 33 is facilitated. In this way, the liquids of different densities in the cooking cavity 21 can be quickly separated. As a result, the liquid of the high density is stored in the cooking cavity 21, and the liquid of the low density is stored in the liquid storage cavity 33. On the other hand, the bubbles can be prevented from being accumulated at the bottom of the separation device 30. As a result, it is possible to prevent the bubbles from driving the separation device 30 to fluctuate, thereby avoiding the influence on the position of the separation device 30. Therefore, the separation device 30 can smoothly separate the liquids of different densities.

After the liquid in the cooking cavity 21 flows into the liquid storage cavity 33, the liquid of the low density floats at a position above the liquid storage cavity 33. The liquid of the high density will be accumulated below the liquid storage cavity 33. In one embodiment, the liquid of the high density located below the liquid storage cavity 33 may flow into the backflow channel 34 from the first liquid flowing portion 341. As the liquid level in the liquid storage cavity 33 rises, the liquid of the high density in the backflow channel 34 may flow into the cooking cavity 21 from the second liquid flowing portion 342. Therefore, the liquids of different densities in the inner pot 20 can be separated. As a result, the liquid of the low density is accumulated in the liquid storage cavity 33, and the liquid of the high density is accumulated in the cooking cavity 21.

In some embodiments, the angle between the inclined flow guide surface 363 and the horizontal plane ranges from 10° to 60°, thereby allowing the flow guide portion 36 to quickly guide the liquids and bubbles in the cooking cavity 21 to the liquid inlet portion 35. Further, the liquid in the cooking cavity 21 can quickly and smoothly flow into the liquid storage cavity 33. Therefore, the liquids of different densities in the cooking cavity 21 can be quickly separated. As a result, the liquid of the high density is stored in the cooking cavity 21, and the liquid of the low density is stored in the liquid storage cavity 33. Meanwhile, the bubbles can be prevented from being accumulated at the bottom of the separation device 30. As a result, it is possible to prevent the bubbles from driving the separation device 30 to fluctuate.

The angle between the inclined flow guide surface 363 and the horizontal plane is 10°, 20°, 30°, 45°, 50° or 60°. In this way, the flow guiding inclined surface 363 can better guide the liquids and bubbles in the cooking cavity 21. Therefore, the liquid in the cooking cavity 21 can quickly and smoothly flow into the liquid storage cavity 33 along the inclined flow guide surface 363, and the bubbles in the cooking cavity 21 can quickly flow to the liquid inlet portion 35 along the inclined flow guide surface 363. Therefore, the bubbles can be prevented from being accumulated at the bottom of the separation device 30. In one embodiment, it is possible to prevent the bubbles from driving the separating device 30 to fluctuate.

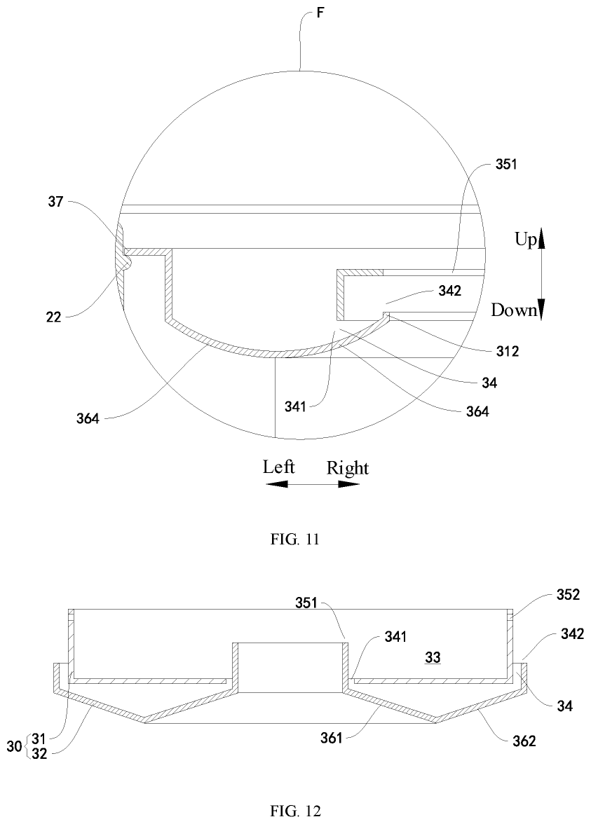

In some other embodiments of the present disclosure, as illustrated in FIG. 10 and FIG. 11, the flow guide portion 36 includes an arc flow guide surface 364. When the liquid in the cooking cavity 21 is boiled, the bubbles and boiled liquids in the cooking cavity 21 may flow to the liquid inlet portion 35 along the arc flow guide surface 364 and then flow into the liquid storage cavity 33 from the liquid inlet portion 35. On the one hand, the liquid in the cooking cavity 21 can quickly flow into the liquid storage cavity 33 along the arc flow guide surface 364, thereby improving the efficiency of the flowing of the liquid in the cooking cavity 21 into the liquid storage cavity 33. Further, the liquids of different densities in the cooking cavity 21 can be quickly separated. As a result, the liquid of the high density is stored in the cooking cavity 21, and the liquid of the low density is stored in the liquid storage cavity 33. On the other hand, the bubbles can be prevented from being accumulated at the bottom of the separation device 30. As a result, it is possible to prevent the bubbles from driving the separation device 30 to fluctuate, thereby avoiding the influence on the position of the separation device 30. The separation device 30 can smoothly separate the liquids of different densities.

After the liquid in the cooking cavity 21 flows into the liquid storage cavity 33, the liquid of the low density will float at a position above the liquid storage cavity 33, and the liquid of the high density will be accumulated below the liquid storage cavity 33. In one embodiment, the liquid of the high density located below the liquid storage cavity 33 may flow into the backflow channel 34 from the first liquid flowing portion 341. As the liquid level in the liquid storage cavity 33 rises, the liquid of the high density in the backflow channel 34 may flow into the cooking cavity 21 from the second liquid flowing portion 342. Therefore, the liquids of different densities in the inner pot 20 can be separated. As a result, the liquid of the low density can be accumulated in the liquid storage cavity 33, and the liquid of the high density can be accumulated in the cooking cavity 21.

In some embodiments, as illustrated in FIG. 11, the arc flow guide surface 364 is a convex surface, thereby allowing the liquid in the cooking cavity 21 to smoothly flow into the liquid storage cavity 33 along the convex surface. In this way, the liquid near the liquid inlet portion 35 may be prevented from being accumulated at the convex surface. The arc flow guide surface 364 can fully guide the liquids and the bubbles in the cooking cavity 21 to flow to the liquid inlet portion 35. Therefore, the liquid in the cooking cavity 21 can quickly and smoothly flow into the liquid storage cavity 33. Further, the bubbles in the cooking cavity 21 can quickly flow to the liquid inlet portion 35 along the arc flow guide surface 364, thereby preventing the bubbles from being accumulated at the bottom of the separation device 30. Therefore, it is possible to prevent the bubbles from driving the separation device 30 to fluctuate.

In some embodiments of the present disclosure, as illustrated in FIG. 6, the separation device 30 includes a liquid storage container 31 and an oil blocking member 32. The liquid storage container 31 is disposed in the cooking cavity 21. The backflow channel 34 is defined by the oil blocking member 32 and the liquid storage container 31.

In some embodiments, the oil blocking member 32 is at least partially disposed in the liquid storage container 31. The flow guide portion 36 is disposed at the outer surface of the bottom wall of the liquid storage container 31. The backflow channel 34 is defined by the oil blocking member 32 and the inner side wall of the liquid storage container 31.

When the liquid in the cooking cavity 21 is boiled, the liquid located near the outer surface of the bottom wall of the liquid storage container 31 may flow to the liquid inlet portion 35 along the flow guide portion 36 and then flow into the liquid storage cavity 33 from the liquid inlet portion 35, and the liquid of the high density in the liquid storage cavity 33 may flow into the backflow channel 34 from the first liquid flowing portion 341, and then flow into the cooking cavity 21 from the second liquid flowing portion 342 along the backflow channel 34. Further, the liquid of the low density may be left in the liquid storage cavity 33. Therefore, the liquids of different densities in the cooking cavity 21 are separated from each other. Therefore, when the cooking appliance 1 is cooking soup, the oil in the meat soup can be separated.

Meanwhile, the bubbles located on the bottom wall of the liquid storage container 31 may flow to the liquid inlet portion 35 along the flow guide portion 36. Therefore, the bubbles can be prevented from being accumulated at the outer surface of the bottom wall of the liquid storage container 31. As a result, it is possible to prevent the bubbles from driving the liquid storage container 31 to fluctuate, thereby avoiding the influence on the position of the liquid storage container 31 and the position of the oil blocking member 32. Therefore, the separation device 30 can smoothly separate the liquids of different densities.

In some other embodiments, as illustrated in FIG. 12, the oil blocking member 32 is disposed outside the liquid storage container 31. The flow guide portion 36 is disposed on the oil blocking member 32. The backflow channel 34 is defined by the oil blocking member 32 and the outer side wall of the liquid storage container 31.

When the liquid in the cooking cavity 21 is boiled, the liquid located near the oil blocking member 32 may flow to the liquid inlet portion 35 along the flow guide portion 36 and then flow into the liquid storage cavity 33 from the liquid inlet portion 35, and the liquid of the high density in the liquid storage cavity 33 may flow into the backflow channel 34 from the first liquid flowing portion 341 and then flow into the cooking cavity 21 from the second liquid flowing portion 342 along the backflow channel 34. Further, the liquid of the low density may be left in the liquid storage cavity 33. Therefore, the liquids of different densities in the cooking cavity 21 are separated from each other. Therefore, when the cooking appliance 1 is cooking soup, the oil in the meat soup can be separated.

Meanwhile, the bubbles located near the oil blocking member 32 may flow to the liquid inlet portion 35 along the flow guide portion 36. Therefore, the bubbles can be prevented from being accumulated on the oil blocking member 32. As a result, it is possible to prevent the bubbles from driving the oil blocking member 32 to fluctuate, thereby avoiding the influence on the position of the oil blocking member 32 and the position of the o liquid storage container 31. Therefore, the separation device 30 can smoothly separate the liquids of different densities.

In some embodiments, the oil blocking member 32 has a first side wall, a second side wall, and a bottom wall. The second side wall is located outside the first side wall. A cross section of the outer peripheral wall of the oil blocking member 32 is annular. The flow guide portion 36 is disposed at the outer surface of the bottom wall of the oil blocking member 32.

As illustrated in FIG. 6, in the embodiment, the separation device 30 is disposed above the cooking cavity 21. When the liquid in the cooking cavity 21 is boiled, the bottom wall of the separation device 30 can easily block the boiling of the liquid above the cooking cavity 21. Therefore, by arranging the flow guide portion 36 at the outer surface of the bottom wall of the separation device 30, the liquid below the bottom wall of the separation device 30 can flow to the liquid inlet portion 35 along the flow guide portion 36. In this way, the bottom wall of the separation device 30 is prevented from blocking the flowing of the liquid into the cooking cavity 21. Therefore, the liquid in the cooking cavity 21 can smoothly flow into the liquid storage cavity 33. As a result, the liquids of different densities in the cooking cavity 21 are smoothly separated.

Meanwhile, when the liquid in the cooking cavity 21 is boiled and the bubbles generated in the cooking cavity 21 move upwards to the outer surface of the bottom wall of the separation device 30, the bubbles may flow to the liquid inlet portion 35 along the flow guide portion 36 from bottom to top. In this way, the bubbles can be prevented from being accumulated at the outer surface of the bottom wall of the separation device 30. As a result, it is possible to prevent the bubbles from driving the separation device 30 to fluctuate when the bubbles fluctuate, thereby avoiding the influence on the position of the separation device 30. Therefore, the separation device 30 can smoothly separate the liquids with different densities.

In some embodiments of the present disclosure, the liquid inlet portion 35 includes a first liquid inlet portion. The flow guide portion 36 includes a first flow guide portion 362. The first flow guide portion 362 extends towards the first liquid inlet portion from bottom to top. The first liquid inlet portion includes a first liquid inlet 352. The first liquid inlet 352 is disposed at the peripheral wall of the liquid storage container 31. When the liquid in the cooking cavity 21 is boiled, the liquid at the side of the cooking cavity 21 may flow upwards to the peripheral wall of the liquid storage container 31 along the first flow guide portion 362, and the liquid located outside the liquid storage cavity 33 flows into the liquid storage cavity 33 from the first liquid inlet 352 at the peripheral wall of the liquid storage container 31. Further, the liquid of the high density in the liquid storage cavity 33 flows into the backflow channel 34 from the first liquid flowing portion 341, and then flows into the liquid storage cavity 33 from the second liquid flowing portion 342 along the backflow channel 34. Therefore, the liquids of different densities in the inner pot 20 can be separated. As a result, the liquid of the high density is stored in the cooking cavity 21, and the liquid of the low density is stored in the liquid storage cavity 33.

In some other embodiments of the present disclosure, the first liquid inlet portion includes an upper opening formed at the peripheral wall of the liquid storage container 31. The flow guide portion 36 includes a first flow guide portion 362. The first flow guide portion 362 extends towards the first liquid inlet portion from bottom to top. When the liquid in the cooking cavity 21 is boiled, the liquid at the side of the cooking cavity 21 flows to the upper opening at the peripheral wall of the liquid storage container 31 along the first flow guide portion 362, and the liquid located outside the liquid storage cavity 33 flows into the liquid storage cavity 33 from the upper opening at the peripheral wall of the liquid storage container 31. Further, the liquid of the high density in the liquid storage cavity 33 flows into the backflow channel 34 from the first liquid flowing portion 341, and then flows into the liquid storage cavity 33 from the second liquid flowing portion 342 along the backflow channel 34. Therefore, the liquids of different densities in the inner pot 20 can be separated. As a result, the liquid of the high density is stored in the cooking cavity 21, and the liquid of the low density is stored in the liquid storage cavity 33.

In some examples, a liquid passing channel is defined by the peripheral wall of the liquid storage container 31 and the peripheral wall of the cooking cavity 21. The upper opening at the peripheral wall of the liquid storage container 31 is in communication with the cooking cavity 21 through the liquid passing channel. When the liquid in the cooking cavity 21 is boiled, the liquid at the side of the cooking cavity 21 flows to the liquid passing channel along the first flow guide portion 362, then flows upwards to the upper opening at the peripheral wall of the liquid storage container 31 through the liquid passing channel, and then flows into the liquid storage cavity 33 from the upper opening at the peripheral wall of the liquid storage container 31.

As illustrated in FIG. 9, in the embodiment, the oil blocking member 32 is at least partially disposed in the liquid storage container 31. The first flow guide portion 362 is disposed at the outer surface of the bottom wall of the liquid storage container 31. The liquid storage container 3 has a first liquid inlet 35 formed at the peripheral wall of the liquid storage container 31. When the liquid in the cooking cavity 21 is boiled, the liquid at the side of the cooking cavity 21 may flow upwards to the peripheral wall of the liquid storage container 31 along the first flow guide portion 362, and the liquid located outside the liquid storage cavity 33 flows into the liquid storage cavity 33 from the first liquid inlet 352 at the peripheral wall of the liquid storage container 31 or from the upper opening at the peripheral wall of the liquid storage container 31.

As illustrated in FIG. 12, in the embodiment, the oil blocking member 32 is disposed outside the liquid storage container 31. The first flow guide portion 362 is disposed at the outer surface of the bottom wall of the oil blocking member 32. The liquid storage container 3 has a first liquid inlet 35 formed at the peripheral wall of the liquid storage container 31. When the liquid in the cooking cavity 21 is boiled, the liquid at the side of the cooking cavity 21 may flow upwards to the peripheral wall of the liquid storage container 31 along the first flow guide portion 362, and the liquid located outside the liquid storage cavity 33 flows into the liquid storage cavity 33 from the first liquid inlet 352 at the peripheral wall of the liquid storage container 31 or from the upper opening at the peripheral wall of the liquid storage container 31.

In some exemplary embodiments of the present disclosure, as illustrated in FIG. 6, FIG. 7, and FIG. 12, the liquid inlet portion 35 further includes a second liquid inlet portion 351. The second liquid inlet portion 351 is disposed on the oil blocking member 32 or the liquid storage container 31. When the liquid in the cooking cavity 21 is boiled, the liquid in the middle of the cooking cavity 21 may flow into the liquid storage cavity 33 from the second liquid inlet portion 351. In this way, the separation device 30 can separate the liquids of different densities in the cooking cavity 21. As a result, the liquid of the high density is stored in the cooking cavity 21, and the liquid of the low density is stored in the liquid storage cavity 33.

The flow guide portion 36 includes a second flow guide portion 361. The second flow guide portion 361 extends towards the second liquid inlet portion 351 from bottom to top. When the liquid in the cooking cavity 21 is boiled, the liquid in the middle of the cooking cavity 21 may flow into the second liquid inlet portion 351 along the second flow guide portion 361 from bottom to top, and then flow into the liquid storage cavity 33 from the second liquid inlet portion 351, and the liquid of the high density in the liquid storage cavity 33 may flow into the backflow channel 34 from the first liquid flowing portion 341 and then flow into the cooking cavity 21 from the second liquid flowing portion 342 along the backflow channel 34. Therefore, the liquids of different densities in the inner pot 20 can be separated. As a result, the liquid of the high density is stored in the cooking cavity 21, and the liquid of the low density is stored in the liquid storage cavity 33.

Meanwhile, when the liquid in the cooking cavity 21 is boiled and the bubbles generated in the cooking cavity 21 move upwards to the outer surface of the bottom wall of the separation device 30, the bubbles may flow into the second liquid inlet portion 351 along the second flow guide portion 361 from bottom to top. Therefore, the bubbles can be prevented from being accumulated at the outer surface of the bottom wall of the separation device 30. As a result, it is possible to prevent the bubbles from driving the separation device 30 to fluctuate when the bubbles fluctuate, thereby avoiding the influence on the position of the separation device 30. Therefore, the separation device 30 can smoothly separate the liquids of different densities.

For example, during the soup cooking of the cooking appliance 1, the meat soup in the cooking cavity 21 may flow into the second liquid inlet portion 351 along the second flow guide portion 361 from bottom to top, and then flow into the liquid storage cavity 33 from the second liquid inlet portion 351. The soup of the high density in the liquid storage cavity 33 flows into the backflow channel 34 from the first liquid flowing portion 341, and then flows into the cooking cavity 21 from the second liquid flowing portion 342 along the backflow channel 34. Therefore, the oil with the low density in the meat soup is stored in the liquid storage cavity 33, thereby separating the oil from the meat soup. In this way, the palatability of the meat soup is improved. In one embodiment, the health-conscious preference for low-fat diets is satisfied. In addition, the diet healthiness of the user can be enhanced.

In some exemplary embodiments of the present disclosure, as illustrated in FIG. 7 and FIG. 12, the first flow guide portion 362 and the second flow guide portion 361 face away from each other. The first flow guide portion 362 and the second flow guide portion 361 extend away from each other from bottom to top. In this way, the first flow guide portion 362 and the second flow guide portion 361 can guide the liquids at different regions in the cooking cavity 21, respectively.

In an exemplary embodiment of the present disclosure, the liquid located near the second flow guide portion 361 in the cooking cavity 21 may flow upwards to the second liquid inlet portion 351 along the second flow guide portion 361, and then flow into the liquid storage cavity 33 from the second liquid inlet portion 351. The liquid located near the first flow guide portion 362 in the cooking cavity 21 may flow upwards to the first liquid inlet portion along the first flow guide portion 362 and then flow into the liquid storage cavity 33 from the first liquid inlet portion.

The first flow guide portion 362 and the second flow guide portion 361 extend away from each other from bottom to top. Therefore, the first flow guide portion 362 and the second flow guide portion 361 can be prevented from interfering with each other. In this way, the flow guide efficiency of the first flow guide portion 362 and the second flow guide portion 361 to the liquid in the cooking cavity 21 can be improved. Therefore, the liquid in the middle of the cooking cavity 21 can flow to the second liquid inlet portion 351 along the second flow guide portion 361, and then flow into the liquid storage cavity 33 from the second liquid inlet portion 351. Further, the liquid at the side of the cooking cavity 21 can flow to the first liquid inlet portion along the first flow guide portion 362 and then flow into the liquid storage cavity 33 from the first liquid inlet portion.

Meanwhile, when the oil blocking member 32 is at least partially disposed in the liquid storage container 31, the first flow guide portion 362 and the second flow guide portion 361 extend away from each other from bottom to top, thereby increasing the depth of the liquid storage cavity 33 and the liquid storage capacity of the liquid storage cavity 33. Therefore, more oil can be stored in the liquid storage cavity 33 when the oil in the cooking cavity 21 is separated. In one embodiment, the oil is prevented from flowing into the cooking cavity 21 from the liquid inlet portion 35.

In some other embodiments of the present disclosure, as illustrated in FIG. 8 and FIG. 9, the liquid storage container 31 has a bottom wall and a peripheral wall. The liquid passing opening 311 is formed at the middle part of the bottom wall of the liquid storage container 31. The oil blocking member 32 is disposed in the liquid storage container 31. The oil blocking member 32 covers the liquid passing opening 311. The second liquid inlet portion 351 is disposed on the oil blocking member 32. The second liquid inlet portion 351 faces towards the liquid passing opening 311.

When the liquid in the cooking cavity 21 is boiled, the liquid in the middle of the cooking cavity 21 may flow into the second liquid inlet portion 351 from the liquid passing opening 311 at the middle part of the bottom wall of the liquid storage container 31, and then flow into the liquid storage cavity 33 from the second liquid inlet portion 351. In this way, the separation device 30 can separate the liquids of different densities in the cooking cavity 21. As a result, the liquid of the high density is stored in the cooking cavity 21, and the liquid of the low density is stored in the liquid storage cavity 33.

The flow guide portion 36 includes a second flow guide portion 361. The second flow guide portion 361 extends towards the second liquid inlet portion 351 from bottom to top. When the liquid in the cooking cavity 21 is boiled, the liquid in the middle of the cooking cavity 21 may flow into the second liquid inlet portion 351 from the liquid passing opening 311 along the second flow guide portion 361 from bottom to top, and then flow into the liquid storage cavity 33 from the second liquid inlet portion 351. Further, the liquid of the high density in the liquid storage cavity 33 may flow into the backflow channel 34 from the first liquid flowing portion 341, and then flow into the cooking cavity 21 from the second liquid flowing portion 342 along the backflow channel 34. Therefore, the liquids of different densities in the inner pot 20 can be separated. As a result, the liquid of the high density is stored in the cooking cavity 21, and the liquid of the low density is stored in the liquid storage cavity 33.

Meanwhile, when the liquid in the cooking cavity 21 is boiled and the bubbles generated in the cooking cavity 21 move upwards to the outer surface of the bottom wall of the liquid storage container 31, the bubbles may flow into the second liquid inlet portion 351 along the second flow guide portion 361 from bottom to top. Therefore, the bubbles can be prevented from being accumulated at the outer surface of the bottom wall of the liquid storage container 31. As a result, it is possible to prevent the bubbles from driving the liquid storage container 31 to fluctuate when the bubbles fluctuate, thereby avoiding the influence on the position of the liquid storage container 31 and the position of the oil blocking member 32. Therefore, the separation device 30 can smoothly separate the liquids of different densities.

For example, during the soup cooking of the cooking appliance 1, the meat soup in the cooking cavity 21 may flow to the second liquid inlet portion 351 from the liquid passing opening 311 along the second flow guide portion 361 from bottom to top and then flow into the liquid storage cavity 33 from the second liquid inlet portion 351. Further, the liquid of the high density in the liquid storage cavity 33 flows into the backflow channel 34 from the first liquid flowing portion 341, and then flows into the cooking cavity 21 from the second liquid flowing portion 342 along the backflow channel 34. Therefore, the oil with the low density in the meat soup is stored in the liquid storage cavity 33, thereby separating the oil from the meat soup. In this way, the palatability of the meat soup is improved. In one embodiment, the health-conscious preference for low-fat diets is satisfied. In addition, the diet healthiness of the user can be enhanced.

In some exemplary embodiments of the present disclosure, as illustrated in FIG. 6 and FIG. 7, the liquid storage container 31 has an annular flange 312 formed at the bottom wall of the liquid storage container 31. The annular flange 312 extends upwards. The liquid passing opening 311 is formed by an upper opening of the annular flange 312. The oil blocking member 32 has a top wall and a peripheral wall. The second liquid inlet portion 351 is disposed at the top wall of the oil blocking member 32. The annular flange 312 may guide the liquid in the cooking cavity 21 to flow to the liquid passing opening 311. In this way, the liquid in the middle of the cooking cavity 21 may flow upwards to the second liquid inlet portion 351 from the liquid passing opening 311 along the annular flange 312 and then flow into the liquid storage cavity 33 from the second liquid inlet portion 351. Further, the liquid of the high density in the liquid storage cavity 33 flows into the backflow channel 34 from the first liquid flowing portion 341, and then flows into the liquid storage cavity 33 from the second liquid flowing portion 342 along the backflow channel 34. Therefore, the liquids of different densities in the inner pot 20 can be separated. As a result, the liquid of the high density is stored in the cooking cavity 21, and the liquid of the low density is stored in the liquid storage cavity 33.

The peripheral wall of the oil blocking member 32 is located at the outer side of the annular flange 312. The backflow channel 34 is at least partially defined by the annular flange 312 and the peripheral wall of the oil blocking member 32. In this way, the liquid of the high density in the liquid storage cavity 33 can flow into the cooking cavity 21 along the backflow channel 34, and the liquid of the low density in the liquid storage cavity 33 can be stored in the liquid storage cavity 33. Therefore, the liquids of different densities in the inner pot 20 is separated.

Meanwhile, the backflow channel 34 is at least partially defined by the annular flange 312 and the peripheral wall of the oil blocking member 32. In this way, the height of the second liquid flowing portion 342 is increased. Further, the oil storage capacity of the separation device 30 can be increased. Furthermore, the oil can be stored in the backflow channel 34 when there is too much oil in the liquid storage cavity 33.

As illustrated in FIG. 6, in the embodiment, an annular liquid storage cavity 33 is defined by the liquid storage container 31 and the peripheral wall of the oil blocking member 32. The annular flange 312 extends in the up-down direction. An annular liquid passing opening 311 is defined by the annular flange 312. The liquid in the middle of the cooking cavity 21 may move upwards along the annular flange 312 and then flow into the annular liquid storage cavity 33 from the second liquid inlet portion 351. The liquid of the high density in the liquid storage cavity 33 flows into the backflow channel 34 from the first liquid flowing portion 341, and then flows into the liquid storage cavity 33 from the second liquid flowing portion 342 along the backflow channel 34. Therefore, the liquids of different densities in the inner pot 20 can be separated. As a result, the liquid of the high density is stored in the cooking cavity 21, and the liquid of the low density is stored in the liquid storage cavity 33.

As illustrated in FIG. 8 and FIG. 9, in some embodiments, the oil blocking member 32 is at least partially disposed in the liquid storage container 31. An annular liquid storage container 33 and an annular backflow channel 34 are defined by the oil blocking member 32 and the liquid storage container 31. The first flow guide portion 362 is located outside the second flow guide portion 361. The second flow guide portion 361 extends towards the axis of the cooking cavity 21 from bottom to top. The second liquid inlet portion 351 is disposed on the top wall of the oil blocking member 32. The liquid in the middle of the cooking cavity 21 may flow upwards to the second liquid inlet portion 351 along the second flow guide portion 361 and then flow into the liquid storage cavity 33 from the second liquid inlet portion 351.

The first flow guide portion 362 extends away from the axis of the cooking cavity 21 from bottom to top. The first liquid inlet portion is disposed at the peripheral wall of the liquid storage container 31. The first liquid inlet portion is located outside the second liquid inlet portion 351. The liquid at the side of the cooking cavity 21 may flow upwards to the first liquid inlet portion along the first flow guide portion 362, and then smoothly flow into the liquid storage cavity 33 from the first liquid inlet portion.

It should be explained here that the terms “inside” and “outside” herein are described with respect to the axis of the cooking cavity 21. A side of the second liquid inlet portion 351 close to the axis of the cooking cavity 21 is referred to as being inside the second liquid inlet portion 351, and a side of the second liquid inlet portion 351 away from the axis of the cooking cavity 21 is referred to as being outside of the second liquid inlet portion 351. In addition, a side of the second flow guide portion 361 close to the axis of the cooking cavity 21 is referred to as being inside the second flow guide portion 361, and a side of the second flow guide portion 361 away from the axis of the cooking cavity 21 is referred to as being outside the second flow guide portion 361.

In some examples, as illustrated in FIG. 9, the lower surface of each of the first flow guide portion 362 and the second flow guide portion 361 is formed as the inclined flow guide surface 363. The first flow guide portion 362 obliquely extends upwards from right to left. The angle between the first flow guide portion 362 and the horizontal plane is denoted as N2, and N2 ranges from 10° to 60°. In an exemplary embodiment of the present disclosure, N2 is 10°, 20°, 30°, 45°, 50°, or 60°. The liquid in the cooking cavity 21 may flow towards the first liquid inlet portion along the first flow guide portion 362 from right to left and then flow into the liquid storage cavity 33 from the first liquid inlet portion.

The second flow guide portion 361 obliquely extends upwards from left to right. The angle between the second flow guide portion 361 and the horizontal plane is denoted as M1, and M1 ranges from 10° to 60°. In an exemplary embodiment of the present disclosure, M1 is 10°, 20°, 30°, 45°, 50°, or 60°. The liquid in the cooking cavity 21 may flow towards the second liquid intake portion 351 along the second flow guide portion 361 from left to right and then flow into the liquid storage cavity 33 from the second liquid intake portion 351.

The right end of the first flow guide portion 362 is connected to the left end of the second flow guide portion 361. In this way, the depth of the liquid storage cavity 33 in the up-down direction can be increased. Therefore, the liquid storage capacity of the liquid storage cavity 33 can be improved. Further, more oil can be stored in the liquid storage cavity 33 when the oil in the cooking cavity 21 is separated, thereby preventing the oil from flowing into the cooking cavity 21 from the liquid inlet portion 35.

In some other examples, as illustrated in FIG. 10 and FIG. 11, the oil blocking member 32 is at least partially disposed in the liquid storage container 31. The lower surface of each of the first flow guide portion 362 and the second flow guide portion 361 is formed as the arc flow guide surface 364. The first flow guide portion 362 extends upwards from right to left. The liquid in the cooking cavity 21 may flow towards the first liquid inlet portion along the first flow guide portion 362 from right to left and then flow into the liquid storage cavity 33 from the first liquid inlet portion. The second flow guide portion 361 extends upwards from left to right. The liquid in the cooking cavity 21 may flow towards the second liquid inlet portion 351 along the second flow guide portion 361 from left to right and then flow into the liquid storage cavity 33 from the second liquid inlet portion 351.

The right end of the first flow guide portion 362 is connected to the left end of the second flow guide portion 361 to form an arc surface protruding downwards. In this way, the depth of the liquid storage cavity 33 in the up-down direction can be increased. Therefore, the liquid storage capacity of the liquid storage cavity 33 can be improved. Further, more oil can be stored in the liquid storage cavity 33 when the oil in the meat soup in cooking cavity 21 is separated, thereby preventing the oil from flowing into the cooking cavity 21 from the liquid inlet portion 35.

In some examples, the first flow guide portion 362 includes an inclined flow guide surface 363. The second flow guide portion 361 includes an arc flow guide surface 364. In other embodiments, the first flow guide portion 362 may include an arc flow guide surface 364, and the second flow guide portion 361 may include an inclined flow guide surface 363

In some exemplary embodiments of the present disclosure, as illustrated in FIG. 6, the cooking body 10 includes the second heating device 50. The second heating device 50 is disposed below the inner pot 20. The projection of the lowest part of the outer surface of the bottom wall of the separation device 30 on the bottom wall of the inner pot 20 is located in the second predetermined region. In this way, the liquid in the corresponding region in the second predetermined region is accurately heated by the second heating device 50, thereby allowing the second heating device 50 to heat the liquid at the bottom of the separation device 30. Further, the liquid in this region can be quickly boiled. The liquid below the separation device 30 may flow into the first liquid inlet portion along the first flow guide portion 362, and then flow into the second liquid inlet portion 351 along the second flow guide portion 361. Therefore, the liquid in the cooking cavity 21 can quickly flow into the liquid storage cavity 33.

In some embodiments, the second predetermined region is a region where the second heating device 50 is projected onto the bottom wall of the inner pot 20. The second heating device 50 can fully heat the liquid in the region corresponding to the second predetermined region. Therefore, the second heating device 50 can fully heat the liquid at the bottom of the separation device 30. The bubbles and boiled liquids in the cooking cavity 21 can flow to the first liquid inlet portion along the first flow guide portion 362 and then flow to the second liquid inlet portion 351 along the second flow guide portion 361. On the one hand, the liquid in the cooking cavity 21 can smoothly flow into the liquid storage cavity 33. On the other hand, the bubbles can be prevented from being accumulated at the bottom of the separation device 30. As a result, it is possible to prevent the bubble from driving the separation device 30 to fluctuate, thereby avoiding the influence on the position of the separation device 30. Therefore, the separation device 30 can smoothly separate the liquids of different densities.

In some embodiments, the second heating device 50 includes heating portions. The heating portions is arranged at intervals horizontally. The projection of the heating portions on the bottom wall of the inner pot 20 in the up-down direction is the projection regions. The whole region defined by the projection regions is the region where the second heating device 50 is projected onto the bottom wall of the inner pot 20. This region is the second predetermined region.

In some examples, the cooking appliance 1 includes a heat conduction plate and a heating pipe. The heating pipe is embedded into the heat conduction plate. The heat conduction plate is in contact with the inner pot. The heating pipe is not in contact with the inner pot 20. The second heating device 50 is formed as a first heating pipe. The second heating device 50 is not in contact with the inner pot 20. The second predetermined region is a region where the heating pipe is projected onto the bottom wall of the inner pot 20.

In some other examples, the cooking appliance 1 includes a winding coil. The winding coil is not in contact with the inner pot 20. When the winding coil is powered on, the winding coil generates a variable magnetic field to heat the inner pot 20. The second heating device 50 is formed as the winding coil. The second heating device 50 is not in contact with the inner pot 20. The second predetermined region is a region where the winding coil is projected onto the bottom wall of the inner pot 20.

In some other embodiments, as illustrated in FIG. 8, the second heating device 50 is in contact with the inner pot 20. A second inner contour line of the second predetermined region is located inside a region where the second heating device 50 is in contact with the bottom wall of the inner pot 20. A second outer contour line of the second predetermined region is located outside a region where the second heating device 50 is in contact with the bottom wall of the inner pot 20. A distance between the second inner contour line and the region where the second heating device 50 is in contact with the bottom wall of the inner pot 20 is smaller than or equal to 10 mm, and/or the second outer contour line and the region where the second heating device 50 is in contact with the bottom wall of the inner pot 20 is smaller than or equal to 10 mm.

In this way, the second heating device 50 can fully heat the liquid in the region corresponding to the second predetermined region. Therefore, the second heating device 50 can fully heat the liquid at the bottom of the separation device 30. The bubbles and boiled liquids in the cooking cavity 21 can flow to the first liquid inlet portion along the first flow guide portion 362 and then flow into the second liquid inlet portion 351 along the second flow guide portion 361. On the one hand, the liquid in the cooking cavity 21 can smoothly flow into the liquid storage cavity 33. On the other hand, the bubbles can be prevented from being accumulated at the bottom of the separation device 30. As a result, it is possible to prevent the bubbles from driving the separation device 30 to fluctuate, thereby avoiding the influence on the position of the separation device 30. Therefore, the separation device 30 can smoothly separate the liquids of different densities.

In some examples, the second heating device 50 includes heating portions. The heating portions is arranged at intervals horizontally. Each of the heating portions is in in contact with the bottom wall of the inner pot 20 at different positions. A whole region defined by the contact positions is the region where the second heating device 50 is in contact with the bottom wall of the inner pot 20.

In some examples, as illustrated in FIG. 8, the second inner contour line of the second predetermined region is located inside the projection of the lowest part of the outer surface of the bottom wall of the separation device 30 on the bottom wall of the inner pot 20. The distance between the second inner contour line of the second predetermined region and the region where the second heating device 50 is in contact with the bottom wall of the inner pot 20 is denoted as H, and H is smaller than or equal to 10 mm. For example, H is 4 mm, 5 mm, 7 mm, 9 mm, or 10 mm.

The second outer contour line of the second predetermined region is located outside the projection of the lowest part of the outer surface of the bottom wall of the separation device 30 on the bottom wall of the inner pot 20. The distance between the second outer contour line of the second predetermined region and the region where the second heating device 50 is in contact with the bottom wall of the inner pot 20 is denoted as S, and S is smaller than or equal to 10 mm. For example, S is 4 mm, 5 mm, 7 mm, 9 mm, or 10 mm.

In some embodiments, the cooking appliance 1 includes a heating plate. The heating plate is in contact with the inner pot 20. The second heating device 50 is formed as the heating plate. The second heating device 50 is in contact with the inner pot 20. The second inner contour line of the second predetermined region is located inside a region where the heating plate is in contact with the inner pot 20. The second outer contour line of the second predetermined region is located outside a region where the heating plate is in contact with the bottom wall of the inner pot 20.

As illustrated in FIG. 8 and FIG. 9, in some embodiments, the oil blocking member 32 is at least partially disposed in the liquid storage container 31. The first flow guide portion 362 is located outside the second flow guide portion 361. The second flow guide portion 361 and the first flow guide portion 362 are each formed as the inclined flow guide surfaces 363. The second flow guide portion 361 obliquely extends upwards from left to right. The first flow guide portion 362 obliquely extends upwards from right to left. The left end of the second flow guide portion 361 is connected to the right end of the first flow guide portion 362. The left end of the second flow guide portion 361 and the right end of the first flow guide portion 362 are the lowest parts of the outer surface of the bottom wall of the liquid storage container 31.

A projection of the right end of the first flow guide portion 362 in the up-down direction on the bottom wall of the inner pot 20 and a projection of the left end of the second flow guide portion 361 in the up-down direction on the bottom wall of the inner pot 20 are located at the region where the second heating device 50 is in contact with the bottom wall of the inner pot 20. The second heating device 50 can fully heat the liquid located at the bottom of the separation device 30. The liquid at the bottom of the liquid storage container 31 can flow to the second liquid inlet portion 351 along the second flow guide portion 361. In this way, the liquid at the bottom of the separation device 30 can flow to the first liquid inlet portion along the first flow guide portion 362. Therefore, the liquid in the cooking cavity 21 can smoothly flow into the liquid storage cavity 33.

Meanwhile, when the liquid at the bottom of the separation device 30 is fully heated by the second heating device 50, the bubbles generated in the cooking cavity 21 move upwards to the bottom of the separation device 30. The bubbles flow to the first liquid inlet portion along the first flow guide portion 362 and then flow into the second liquid inlet portion 351 along the second flow guide portion 361. Therefore, the bubbles can be prevented from being accumulated at the bottom of the separation device 30. As a result, it is possible to prevent the bubbles from driving the separation device 30 to fluctuate, thereby avoiding the influence on the position of the separation device 30. Therefore, the separation device 30 can smoothly separate the liquids of different densities.

As illustrated in FIG. 10 and FIG. 11, in some other embodiments, the first flow guide portion 362 is located outside the second flow guide portion 361. The second flow guide portion 361 and the first flow guide portion 362 are each formed as the arc flow guide surfaces 364. The second flow guide portion 361 extends upwards from left to right. The first flow guide 362 extends upwards from right to left. The left end of the second flow guide portion 361 is connected to the right end of the first flow guide portion 362. The left end of the second flow guide portion 361 and the right end of the first flow guide portion 362 are the lowest parts of the outer surface of the bottom wall of the liquid storage container 31. It needs to be understood that the above-mentioned directions are limited only to facilitate the description of the drawings, rather than limiting the actual arrangement position and orientation of the cooking appliance 1.

The projection of the left end of the second flow guide portion 361 on the bottom wall of the inner pot 20 in the up-down direction and a projection of the right end of the first flow guide portion 362 on the bottom wall of the inner pot 20 in the up-down direction are located at the region where the second heating device 50 is in contact with the bottom wall of the inner pot 20. The second heating device 50 can fully heat the liquid located at the bottom of the liquid storage container 31. The liquid at the bottom of the separation device 30 can flow to the first liquid inlet portion along the first flow guide portion 362. The liquid in the cooking cavity 21 can smoothly flow into the liquid storage cavity 33. The liquid at the bottom of the separation device 30 can flow to the second liquid inlet portion 351 along the second flow guide portion 361.

Meanwhile, when the liquid at the bottom of the separation device 30 is fully heated by the second heating device 50, the bubbles generated in the cooking cavity 21 move upwards to the bottom of the separation device 30 and then flow into the first liquid inlet portion along the first flow guide portion 362. The bubbles flow into the second liquid inlet portion 351 along the second flow guide portion 361. In this way, the bubbles are prevented from being accumulated at the bottom of the separation device 30. As a result, it is possible to prevent the bubbles from driving the separation device 30 to fluctuate, thereby avoiding the influence on the position of the separation device 30. Therefore, the separation device 30 can smoothly separate the liquids of different densities.

In some embodiments of the present disclosure, as illustrated in FIG. 7, the inner pot 20 is provided with a positioning protrusion 22 at a side wall of the inner pot 20. The separation device 30 is provided with a support edge 37. The support edge 37 is engaged with the positioning protrusion 22. The positioning protrusion 22 can support the support edge 37. Further, the separation device 30 is supported in the inner pot 20, thereby allowing the liquid in the cooking cavity 21 to flow into the liquid storage cavity 33 from the liquid inlet portion 35. The liquid of the high density in the liquid storage cavity 33 may flow into the backflow channel 34 from the first liquid flowing portion 341, and then flow into the cooking cavity 21 from the second liquid flowing portion 342 along the backflow channel 34. In addition, the liquid of the low density may be left in the liquid storage cavity 33. As a result, the liquids of different densities in the cooking cavity 21 are separated from each other. Therefore, when the cooking appliance 1 is cooking soup, the oil in the meat soup can be separated.

Meanwhile, when the liquid in the cooking cavity 21 is boiled and the bubbles generated in the cooking cavity 21 move upwards to the outer surface of the bottom wall of the separation device 30, the bubbles may flow to the liquid inlet portion 35 along the flow guide portion 36. In this way, the bubbles are prevented from being accumulated at the outer surface of the bottom wall of the separation device 30. As a result, it is possible to prevent the bubbles from driving the separation device 30 to fluctuate when the bubbles fluctuate, thereby avoiding the influence on the position of the separation device 30. Therefore, the separation device 30 can smoothly separate the liquids of different densities.

In some embodiments of the present disclosure, the separation device 30 is provided with a protruding rib at a side wall of the separation device 30. The protruding rib is engaged with the side wall of the inner pot 20 to arrange the separation device 30 in the inner pot 20. In this way, the liquid in the cooking cavity 21 can flow into the liquid storage cavity 33 from the liquid inlet portion 35. The liquid of the high density in the liquid storage cavity 33 may flow into the backflow channel 34 from the first liquid flowing portion 341 and then flow into the cooking cavity 21 from the second liquid flowing portion 342 along the backflow channel 34, and the liquid of the low density may be left in the liquid storage cavity 33. As a result, the liquids of different densities in the cooking cavity 21 are separated from each other. Therefore, when the cooking appliance 1 is cooking soup, the oil in the meat soup can be separated.

Meanwhile, when the liquid in the cooking cavity 21 is boiled and the bubbles generated in the cooking cavity 21 move upwards to the outer surface of the bottom wall of the separation device 30, the bubbles may flow to the liquid inlet portion 35 along the flow guide portion 36. In this way, the bubbles can be prevented from being accumulated at the outer surface of the bottom wall of the separation device 30. As a result, it is possible to prevent the bubbles from driving the separation device 30 to fluctuate when the bubbles fluctuate, thereby avoiding the influence on the position of the separation device 30. Therefore, the separation device 30 can smoothly separate the liquids of different densities.

In some embodiments of the present disclosure, the separation device 30 is supported at an edge of the inner pot 20 to arrange the separation device 30 in the inner pot 20. In this way, the liquid in the cooking cavity 21 can flow into the liquid storage cavity 33 from the liquid inlet portion 35. The liquid of the high density in the liquid storage cavity 33 may flow into the backflow channel 34 from the first liquid flowing portion 341 and then flow into the cooking cavity 21 from the second liquid flowing portion 342 along the backflow channel 34, and the liquid of the low density may be left in the liquid storage cavity 33. As a result, the liquids of different densities in the cooking cavity 21 are separated from each other. Therefore, when the cooking appliance 1 is cooking soup, the oil in the meat soup can be separated.

Meanwhile, when the liquid in the cooking cavity 21 is boiled and the bubbles generated in the cooking cavity 21 move upwards to the outer surface of the bottom wall of the separation device 30, the bubbles may flow into the liquid inlet portion 35 along the flow guide portion 36. In this way, the bubbles can be prevented from being accumulated at the outer surface of the bottom wall of the separation device 30. As a result, it is possible to prevent the bubbles from driving the separation device 30 to fluctuate when the bubbles fluctuate, thereby avoiding the influence on the position of the separation device 30. Therefore, the separation device 30 can smoothly separate the liquids of different densities.

In some embodiments of the present disclosure, the separation device 30 is supported at a bottom wall of the inner pot 20 to provide the separation device 30 in the inner pot 20. In this way, the liquid in the cooking cavity 21 can flow into the liquid storage cavity 33 from the liquid inlet portion 35. The liquid of the high density in the liquid storage cavity 33 may flow into the backflow channel 34 from the first liquid flowing portion 341 and then flow into the cooking cavity 21 from the second liquid flowing portion 342 along the backflow channel 34, and the liquid of the low density may be left in the liquid storage cavity 33. As a result, the liquids of different densities in the cooking cavity 21 are separated from each other. Therefore, when the cooking appliance 1 is cooking soup, the oil in the meat soup can be separated.

Meanwhile, when the liquid in the cooking cavity 21 is boiled and the bubbles generated in the cooking cavity 21 move upwards to the outer surface of the bottom wall of the separation device 30, the bubbles may flow to the liquid inlet portion 35 along the flow guide portion 36. In this way, the bubbles can be prevented from being accumulated at the outer surface of the bottom wall of the separation device 30. As a result, it is possible to prevent the bubbles from driving the separation device 30 to fluctuate when the bubbles fluctuate, thereby avoiding the influence on the position of the separation device 30. Therefore, the separation device 30 can smoothly separate the liquids of different densities.

Other arrangements and operations of the cooking appliance 1 according to the embodiments of the present disclosure, and the description thereof in detail will be omitted herein.

In the description of this specification, descriptions with reference to the terms “an embodiment,” “some embodiments,” “examples,” “specific examples,” or “some examples” etc., mean that specific features, structure, materials or characteristics described in conjunction with the embodiment or example are included in at least one embodiment or example of the present disclosure. In this specification, the schematic representations of the above terms do not necessarily refer to the same embodiment or example. In one embodiment, the described specific features, structures, materials or characteristics may be combined in any one or more embodiments or examples in a suitable manner.

What is claimed is:

1. A cooking appliance, comprising:
a cooking body defining an accommodation cavity;
an inner pot provided in the accommodation cavity and defining a cooking cavity; and
a separation device provided in the inner pot and having a liquid storage cavity and a backflow channel, the backflow channel having a first liquid flowing portion and a second liquid flowing portion disposed above the first liquid flowing portion, wherein the liquid storage cavity is in communication with the backflow channel through the first liquid flowing portion, wherein the cooking cavity is in communication with the backflow channel through the second liquid flowing portion, and wherein the separation device has a liquid inlet portion, the liquid storage cavity being in communication with the cooking cavity through the liquid inlet portion,
wherein the separation device is provided with a flow guide portion at a bottom of the separation device, the flow guide portion being configured to guide a liquid in the cooking 13 cavity to flow towards the liquid inlet portion.

2. The cooking appliance according to claim 1, wherein:
the cooking body comprises a first heating device located below a bottom wall of the inner pot, the first heating device comprising a first heating element and a second heating element that are capable of operating independently of each other; and
the flow guide portion is located at a position corresponding to the first heating device.

3. The cooking appliance according to claim 2, wherein:
the first heating element and the second heating element are each of an annular structure; and
the first heating element is located outside the second heating element.

4. The cooking appliance according to claim 3, wherein a projection of a lowest part of an outer surface of a bottom wall of the separation device on the bottom wall of the inner pot is located in a first predetermined region, wherein:
the first predetermined region is a region where a part between the first heating element and the second heating element is projected onto the bottom wall of the inner pot; or
the first heating element and the second heating element are both in contact with the inner pot, a first inner contour line of the first predetermined region being located inside a region where the second heating element is in contact with the bottom wall of the inner pot, a first outer contour line of the first predetermined region being located outside a region where the first heating element is in contact with the bottom wall of the inner pot, a distance between the first inner contour line and the region where the second heating element is in contact with the bottom wall of the inner pot being smaller than or equal to 15 mm and/or a distance between the first outer contour line and the region where the first heating element is in contact with the bottom wall of the inner pot being smaller than or equal to 15 mm.

5. The cooking appliance according to claim 2, wherein:
the liquid inlet portion comprises a first liquid inlet portion; and
the flow guide portion comprises a first flow guide portion located at a position corresponding to the first heating element and extending towards the first liquid inlet portion from bottom to top.

6. The cooking appliance according to claim 5, wherein:
the liquid inlet portion further comprises a second liquid inlet portion; and
the flow guide portion further comprises a second flow guide portion located at a position corresponding to the second heating element and extending towards the second liquid inlet portion from bottom to top.

7. The cooking appliance according to claim 6, wherein:
the first flow guide portion and the second flow guide portion are each of an annular structure; and
the first flow guide portion is located outside the second flow guide portion.

8. The cooking appliance according to claim 6, wherein the first flow guide portion and the second flow guide portion extend away from each other from bottom to top.

9. The cooking appliance according to claim 6, wherein the first flow guide portion and/or the second flow guide portion comprise an inclined flow guide surface and/or an arc flow guide surface.

10. The cooking appliance according to claim 9, wherein the first flow guide portion and/or the second flow guide portion comprise the inclined flow guide surface, an angle between the inclined flow guide surface and a horizontal plane ranging from 10° to 60°.

11. The cooking appliance according to claim 9, wherein the first flow guide portion and/or the second flow guide portion comprise the arc flow guide surface, the arc flow guide surface being a convex surface.

12. The cooking appliance according to claim 6, wherein the separation device comprises:
a liquid storage container provided in the cooking cavity; and
an oil blocking member, the backflow channel being defined by the oil blocking member and the liquid storage container,
wherein the oil blocking member is at least partially disposed in the liquid storage container, and the first flow guide portion and the second flow guide portion are disposed at an outer surface of a bottom wall of the liquid storage container; or
wherein the oil blocking member is disposed outside the liquid storage container, and the first flow guide portion and the second flow guide portion are disposed at the oil blocking member.

13. The cooking appliance according to claim 12, wherein the first liquid inlet portion comprises a first liquid inlet formed at a peripheral wall of the liquid storage container or an upper opening formed at the peripheral wall of the liquid storage container.

14. The cooking appliance according to claim 12, wherein the second liquid inlet portion is disposed at the oil blocking member or the liquid storage container.

15. The cooking appliance according to claim 12, wherein:
the first liquid inlet portion comprises a plurality of first liquid inlets formed at a peripheral wall of the liquid storage container; and
a total area of the plurality of first liquid inlets is greater than or equal to 20 mm².

16. The cooking appliance according to claim 12, wherein:
the liquid storage container has a bottom wall and a peripheral wall, a liquid passing opening being formed at a middle part of the bottom wall of the liquid storage container;
the oil blocking member is disposed in the liquid storage container and covers the liquid passing opening; and
the second liquid inlet portion is disposed at the oil blocking member and faces towards the liquid passing opening.

17. The cooking appliance according to claim 16, wherein:
the bottom wall of the liquid storage container has an annular flange extending upwards, the liquid passing opening being formed by an upper opening of the annular flange;
the oil blocking member has a top wall and a peripheral wall;
the second liquid inlet portion is disposed at the top wall of the oil blocking member;
the peripheral wall of the oil blocking member is located outside the annular flange; and
the backflow channel is at least partially defined by the annular flange and the peripheral wall of the oil blocking member.

18. The cooking appliance according to claim 1, wherein:
the cooking body comprises a second heating device provided below the inner pot; and
a projection of a lowest part of an outer surface of a bottom wall of the separation device on a bottom wall of the inner pot is located in a second predetermined region, wherein:
the second predetermined region is a region where the second heating device is projected onto the bottom wall of the inner pot; or
the second heating device is in contact with the inner pot, a second inner contour line of the second predetermined region being located inside a region where the second heating device is in contact with the bottom wall of the inner pot, a second outer contour line of the second predetermined region being located outside the region where the second heating device is in contact with the bottom wall of the inner pot, a distance between the second inner contour line and the region where the second heating device is in contact with the bottom wall of the inner pot being smaller than or equal to 10 mm and/or a distance between the second outer contour line and the region where the second heating device is in contact with the bottom wall of the inner pot being smaller than or equal to 10 mm.

19. The cooking appliance according to claim 1, wherein the flow guide portion extends towards at least one liquid inlet portion from bottom to top, wherein the flow guide portion comprises an inclined flow guide surface and/or an arc flow guide surface,
wherein the flow guide portion comprises the inclined flow guide surface, an angle between the inclined flow guide surface and a horizontal plane ranging from 10° to 60°, and
wherein the flow guide portion comprises the arc flow guide surface, the arc flow guide surface being a convex surface.

20. The cooking appliance according to claim 1, wherein the inner pot is provided with a positioning protrusion at a side wall of the inner pot, and the separation device is provided with a support edge engaged with the positioning protrusion; or
the separation device is provided with a protruding rib at a side wall of the separation device, the protruding rib being engaged with the side wall of the inner pot; or
a separation surface is supported at an edge of the inner pot; or
the separation surface is supported at a bottom wall of the inner pot.
